(19) United States
(12) Patent Application Publication
(10) Pub. No.: US 2015/0350912 A1
(43) Pub. Date: Dec. 3, 2015

(54) RESIDENTIAL SERVICE DELIVERY BASED ON UNIQUE RESIDENTIAL APN

(71) Applicant: Telefonaktiebolaget L M Ericsson (publ), Stockholm (SE)

(72) Inventors: Kenneth HEAD, Southlake, TX (US); Ronan MCLAUGHLIN, Long Valley, NJ (US)

(21) Appl. No.: 14/622,739

(22) Filed: Feb. 13, 2015

Related U.S. Application Data
(60) Provisional application No. 62/003,958, filed on May 28, 2014.

(51) Int. Cl. H04W 12/08; H04L 29/12; H04L 29/06

(52) U.S. Cl. CPC H04W 12/08; H04L 63/105; H04L 63/08; H04L 61/2007

(57) ABSTRACT

A method, in a network device, of delivering a residential service to an electronic device of a user over a network. The method comprises receiving a request from the electronic device of the user to access a residential service associated with the user; and retrieving a unique Access Point Name (APN) identifier associated with the residential service of the user. The method continues with determining that the electronic device is authorized to access the requested residential service based on the unique APN identifier associated with the residential service of the user; and responsive to the determination, transmitting an access authorization for the electronic device of the user to access the requested residential service.

### CROSS-REFERENCE TO RELATED APPLICATIONS

This application claims the benefit of U.S. Provisional Application No. 62/003,958, filed May 28, 2014, which is hereby incorporated by reference.

### FIELD

Embodiments of the invention relate to the field of residential telecommunication services; and more specifically, to residential telecommunication service delivery based on unique residential Access Point Name (APN).

### BACKGROUND

In residential telecommunication services, a residential gateway allows the connection of a residential network (e.g. a local area network (LAN)) to a wide area network (WAN). The WAN can be a larger computer network, or the Internet. WAN connectivity may be provided through DSL, cable modem, a broadband mobile phone network, or other connections. A residential gateway (or home gateway) is a networking device within the residence of a subscriber used to provide Quality of Service (QoS) and simultaneously support different types of services. For example a residential gateway can be used to deliver voice, video and data services to a residence.

The telecom industry has been investigating solutions for “virtualizing” the home residential environment. The intent is to transfer the residential gateway and move its functionalities to the provider's network. With this virtualization abstracted to the provider network, functionality/flexibility can be achieved in offering differential services to the data devices in the home. Such differential services include content filtering/parental control of devices meant for children etc.

Typical data access in the home will either be wired or wireless (including IEEE 802.11 family) with a service provider transport of Cable Docsis, Digital Subscriber Line (DSL) or fiber to the ‘x’ networks (FTTx) like Gigabit Passive Optical Network (GPON) or Ethernet Passive Optical Network (EPON) terminating in Cable Modem Termination Systems (CMTS), WiFi Access Gateways (WAGs) or Broadband Network Gateways (BNGs).

Today there is no standard based framework for defining a “Virtual Home Gateway” and its associated services. Many competing solutions exist without a framework for service delivery. Only grouping individual devices into a service instance lacks focus and clarity and only limited remote access to the home network and its services is available.

### SUMMARY

A method, in a network device, of delivering a residential service to an electronic device of a user over a network. The method comprises receiving a request from the electronic device of the user to access a residential service associated with the user; and retrieving a unique Access Point Name (APN) identifier associated with the residential service of the user. The method continues with determining that the electronic device is authorized to access the requested residential service based on the unique APN identifier associated with the residential service of the user; and responsive to the determination, transmitting an access authorization for the electronic device of the user to access the requested residential service.

A non-transitory machine-readable storage medium supporting delivering a residential service to an electronic device of a user over a network. The storage medium has instructions stored therein, which when executed by a processor, cause the processor to perform operations at a network device. The operations include receiving a request from an electronic device of the user to access a residential service associated with the user; retrieving a unique Access Point Name (APN) identifier associated with the residential service of the user; determining that the electronic device is authorized to access the requested residential service based on the unique APN identifier associated with the residential service of the user; and responsive to the determination, transmitting an access authorization for the electronic device of the user to access the requested residential service.

The embodiments of the disclosed techniques provide a method of delivering differentiated residential services to end user devices based on a unique APN associated to each residential service. The embodiments of the disclosed techniques enable seamless mobility and handoff between fixed and mobile networks by providing access to users to their residential services regardless of where and how they connect to the network. The embodiments further allow for the collective residential gateways of a fixed operator access network to be virtualized and decomposed into a number of APNs which will reside in a cloud based core network. The embodiments of the disclosed techniques allow for each APN and/or associated bearers to be mapped to service chains in SDN/NFV implementations and allow the application of advanced policies and service chaining.

### BRIEF DESCRIPTION OF THE DRAWINGS

The invention may best be understood by referring to the following description and accompanying drawings that are used to illustrate embodiments of the invention. In the drawings:

FIG. 1A illustrates a diagram of a residential gateway for delivering residential services to customers based on a unique APN associated with the residential service in accordance with one embodiment.

FIG. 1B illustrates a diagram of an exemplary virtual residential gateway in accordance with one embodiment.

FIG. 1C illustrates a diagram of a residential gateway for providing service differentiation to a user of a residential service in accordance with one embodiment.

FIG. 2 illustrates a flow diagram for delivering a residential service to electronic devices of a user over a network based on a unique APN associated with the residential service, in accordance with one embodiment.

FIG. 3 illustrates a flow diagram for authorizing access to a residential service to an unregistered electronic device of a user.

FIG. 4A illustrates an exemplary flow diagram of operations for providing access to a residential service based on a unique APN associated with the residential service in accordance with one embodiment.

FIG. 4B illustrates an exemplary flow diagram of operations for determining a charging policy for the user according to a unique APN associated with its residential service in accordance with one embodiment.

FIG. 4C illustrates an exemplary flow diagram of operations for providing access to a residential service of an unregistered electronic device in accordance with one embodiment.

FIG. 5A illustrates connectivity between network devices (NDs) within an exemplary network, as well as three exemplary implementations of the NDs, according to some embodiments of the invention.

FIG. 5B illustrates an exemplary way to implement a special-purpose network device according to some embodiments of the invention.

FIG. 5C illustrates various exemplary ways in which virtual network elements (VNEs) may be coupled according to some embodiments of the invention.

FIG. 5D illustrates a network with a single network element (NE) on each of the NDs, and within this straight forward approach contrasts a traditional distributed approach (commonly used by traditional routers) with a centralized approach for maintaining reachability and forwarding information (also called network control), according to some embodiments of the invention.

FIG. 5E illustrates the simple case of where each of the NDs implements a single NE, but a centralized control plane has abstracted multiple of the NEs in different NDs into (to represent) a single NE in one of the virtual network(s), according to some embodiments of the invention.

FIG. 5F illustrates a case where multiple VNEs are implemented on different NDs and are coupled to each other, and where a centralized control plane has abstracted these multiple VNEs such that they appear as a single VNE within one of the virtual networks, according to some embodiments of the invention.

### DETAILED DESCRIPTION

The following description describes methods and apparatus for delivering residential services to end user devices based on a unique residential APN associated with the residential service. In the following description, numerous specific details such as logic implementations, opcodes, means to specify operands, resource partitioning/sharing/duplication implementations, types and interrelationships of system components, and logic partitioning/integration choices are set forth in order to provide a more thorough understanding of the present invention. It will be appreciated, however, by one skilled in the art that the invention may be practiced without such specific details. In other instances, control structures, gate level circuits and full software instruction sequences have not been shown in detail in order not to obscure the invention. Those of ordinary skill in the art, with the included descriptions, will be able to implement appropriate functionality without undue experimentation.

References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

Bracketed text and blocks with dashed borders (e.g., large dashes, small dashes, dot-dash, and dots) may be used herein to illustrate optional operations that add additional features to embodiments of the invention. However, such notation should not be taken to mean that these are the only options or optional operations, and/or that blocks with solid borders are not optional in certain embodiments of the invention.

In the following description and claims, the terms “coupled” and “connected,” along with their derivatives, may be used. It should be understood that these terms are not intended as synonyms for each other. “Coupled” is used to indicate that two or more elements, which may or may not be in direct physical or electrical contact with each other, co-operate or interact with each other. “Connected” is used to indicate the establishment of communication between two or more elements that are coupled with each other.

An electronic device stores and transmits (internally and/or with other electronic devices over a network) code (which is composed of software instructions and which is sometimes referred to as computer program code or a computer program) and/or data using machine-readable media (also called computer-readable media), such as machine-readable storage media (e.g., magnetic disks, optical disks, read only memory (ROM), flash memory devices, phase change memory) and machine-readable transmission media (also called a carrier) (e.g., electrical, optical, radio, acoustical or other form of propagated signals—such as carrier waves, infrared signals). Thus, an electronic device (e.g., a computer) includes hardware and software, such as a set of one or more processors coupled to one or more machine-readable storage media to store code for execution on the set of processors and/or to store data. For instance, an electronic device may include non-volatile memory containing the code since the non-volatile memory can persist code/data even when the electronic device is turned off (when power is removed), and while the electronic device is turned on that part of the code that is to be executed by the processor(s) of that electronic device is typically copied from the slower non-volatile memory into volatile memory (e.g., dynamic random access memory (DRAM), static random access memory (SRAM)) of that electronic device. Typical electronic devices also include a set or one or more physical network interface(s) to establish network connections (to transmit and/or receive code and/or data using propagating signals) with other electronic devices. One or more parts of an embodiment of the invention may be implemented using different combinations of software, firmware, and/or hardware.

A network device (ND) is an electronic device that communicatively interconnects other electronic devices on the network (e.g., other network devices, end-user devices). Some network devices are “multiple services network devices” that provide support for multiple networking functions (e.g., routing, bridging, switching, Layer 2 aggregation, session border control, Quality of Service, and/or subscriber management), and/or provide support for multiple application services (e.g., data, voice, and video).

Residential APN

3GPP APNs is a feature of 3GPP Evolved Packet Gateway (EPG). It amounts to a virtual router construct allowing a subset of devices to be mapped into one service and/or routing domain. Uses of APNs include hosted 3GPP mobile core, one service for a provider or for another service provider, or an APN exclusively for the use of a (large) corporation as a Private Virtual Network.

The embodiments described below, allow the application or usage of the 3GPP Access Point Name (APN) service/construct for a residential access service offering. These embodiments introduce the assignment of a single Residential APN per virtualized residential home gateway (vHGW) i.e. One residence equals one APN. In these embodiments, the use of multiple residential APNs per residence is not precluded. The assignment of an APN to a residential service can further be extended and can be scaled to commercial grade service levels using Network Function Virtualization (NFV) and Cloud Execution Environments (CEEs) in data centers. A key advantage of the use of residential APN is the fulfillment of the “Home on the Go”, “Home anywhere”, such that an individual may remotely access their home network through a public network access point or a mobile network access point (e.g. the embodiments provide access to an individual's home resources from public hotspots or even Long Term Evolution (LTE) access). For example a subscriber may print their daily schedule on their home printer while sitting in a local coffee shop. The embodiments described below are equally applicable and extensible to a Small/Medium Business (SMB) or Enterprise deployment model SMB APN (SMBAPN) or Enterprise APN (EAPN).

The embodiments described below introduce a Residential Gateway using residential APN which repurposes the concepts of 3GPP APNs as a service instance for a single “residence” and puts a high degree of definition on the service concept. A residential APN can leverage and apply all developed and defined resources of a mobile core but more focused on a residential service offering. Mobility and remote access is instantly obtained by extending the APN into the mobile domain enabling a subscriber to seamlessly attach to their home network environment over any available internet access, extend their home service to other locations, for example, a vacation home, or even permanently move the virtual (network) home to a new residence instantly.

The advantage of using a single APN for a residential service instance instantly brings clarity, service focus and a rich developmental history from the use of APNs in the mobile network domain to a fixed access residential network domain. Residential APNs can be used to allow different access classes and the association of bearer types (default and dedicated bearers) for all services delivered to a Residential Network leveraging existing mobile APN constructs. In some embodiments, extending the Residential APN to a Mobile Network/Mobile Gateway allows all residential service to be reached while roaming outside the home. Key elements such as differential services, localized printing, remote “on the go” access are all achieved in a uniform and highly standardized fashion. In some embodiments, further scaling of this concept can be achieved using Network Function Virtualization NFV technology.

The embodiments of the inventions allow service providers to virtualize and “move” the traditional home gateway, typically the home Network Address Translation (NAT) router back into the network data center thus exposing the many devices in the home to potential service differentiation.

Residential Gateway with Unique APN

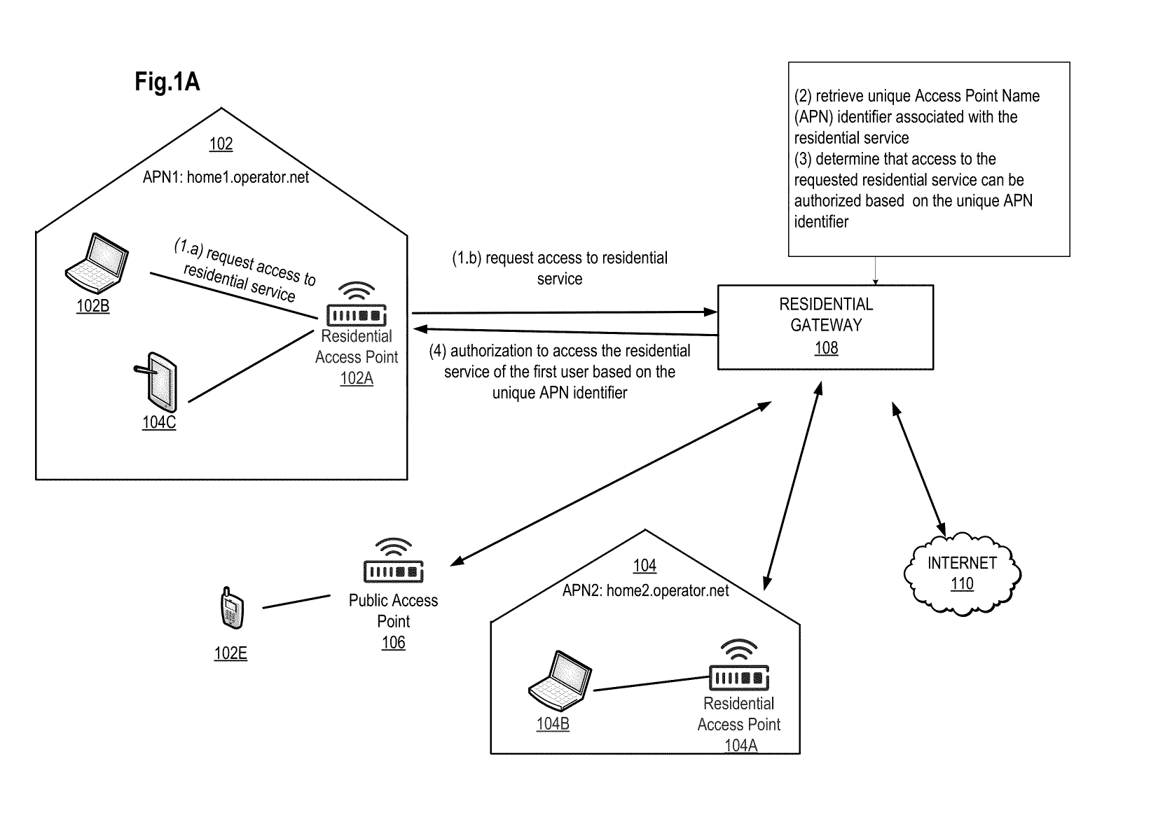

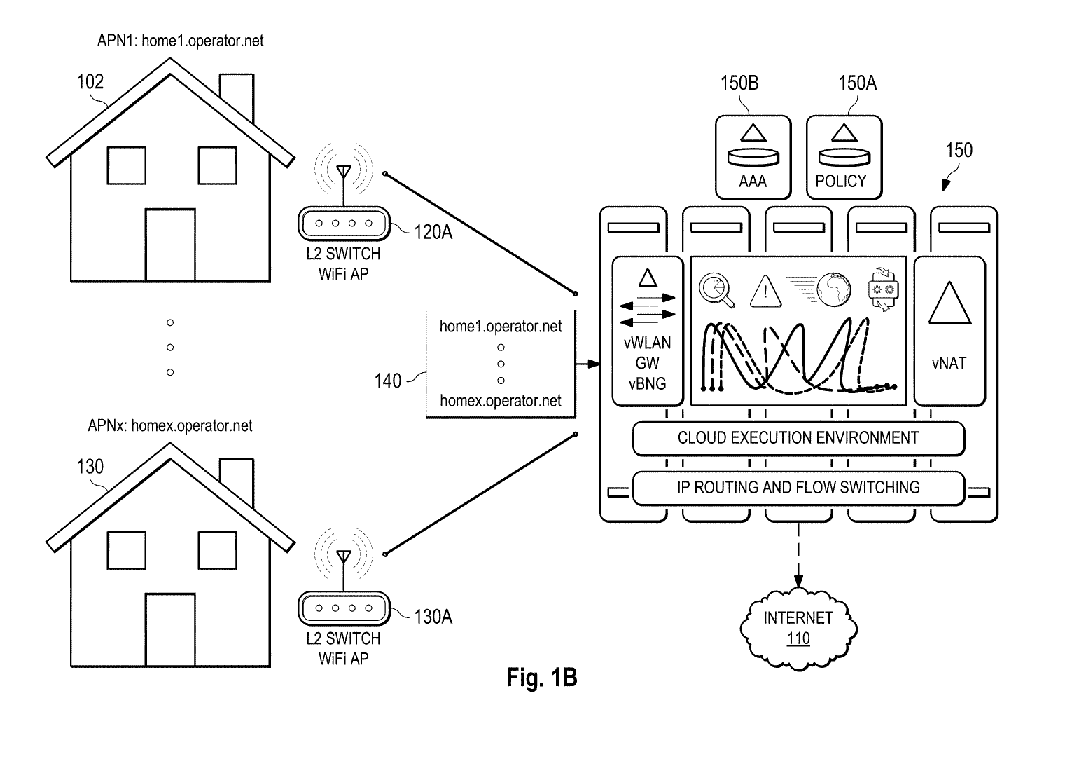

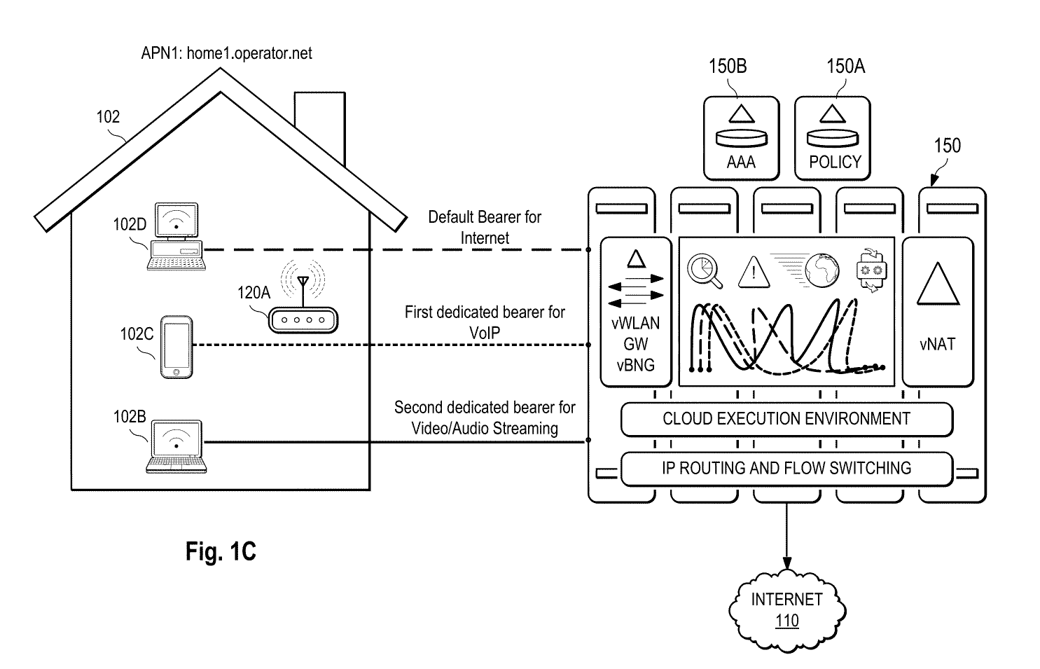

FIG. 1A illustrates a diagram of a residential gateway for delivering residential services to customers based on a unique APN associated with the residential service in accordance with one embodiment. Each residence of a user (102 and 104) is connected to the residential gateway 108 to access telecommunication residential services. In some embodiments, a telecommunication residential service (or the residential service hereafter) of a user is offered by a service provider and is defined for a subscriber. For example, the residential service is an Internet Protocol based service and allows the user to define one or more services. In one example, the residential service includes an Internet access, audio/video streaming, home security services, smarthome services, remote access to the residential network located at the residence of the subscriber, etc. Further, the residential service may be associated with one or more users. For example, a group of users (e.g. family, roommates, employee of a small business, etc.) living or working at the same residence may have access to the same residential service. In these examples, each residential service may be associated with a single billing account and with security and usage parameters specific to the service.

The residence 102 of the first user, includes an Access Point 102A, a first electronic device 102B, and a second electronic device 104C. In some embodiments, the access point 102A is connected to the residential gateway 108 through a fixed wired network. In other embodiments the access point is connected to the residential gateway 108 through a mobile network. The access point 102A is further connected to the electronic devices 102B and 104C through a wired connection (e.g. Ethernet, xDSL, xPON, FTTx, etc.) or a wireless connection (WiFi, etc.). The residential service of the user is associated with a unique Access Point Name (APN) identifier (e.g. APN1: home1.operator.net), which defines the type of residential services that the user has subscribed to. For example, the APN may define the type of network connection to be created when a user requests connection to its residential service (e.g.: which IP addresses should be assigned to the user's electronic devices, which security methods should be used, what bearers should be set up for the residence and the QoS profiles associated with the bearers etc.). The unique APN further allows a user of a residential service to remotely connect to its residential network. In some embodiments, the residence of the first user 102 is associated with a unique residential identifier (referred to as first residential ID hereafter). The first residential ID may be assigned by a residential service provider when the first user subscribes to their residential service. The residential ID may be a unique alphanumerical associated with the residence of the user and based on a unique identifier of the user (e.g. the residential ID may be based on a social security number of the user, an email address of the user, the residence address of the user, the name of the user, the phone number of the user etc . . . ) which uniquely identifies the residence at a determined location.

The residence of the second user 104 includes an Access Point 104A and an electronic device 104B. The access point 104A is connected to the residential gateway 108 through a fixed wired network or through a mobile network. The access point 104A is further connected to the user's electronic devices 104B through a wired (e.g. Ethernet, xDSL, xPON, FTTx, etc.) and/or wireless connection (WiFi, etc). The residential service of the second user is associated with a second unique Access Point Name (e.g. APN2: home2.operator.net) identifier, which defines the type of residential service that the second user has subscribed to. The second APN is unique to the residential service of the second user and is different from the first APN of the first user. Each residential service is uniquely identified with its respective APN. The unique APN may be associated with different types of services offered to the user, as well as various security settings and billing parameters that are specific to the residential service of the user and which may be customized for each user. In some embodiments, the residence of the second user 104 is associated with a unique residential identifier (referred to a second residential ID hereafter). The second residential ID may be assigned by a residential service provider when the second user subscribes to their residential service. Even though the examples presented herein refer to a user per residence, one would understand that a plurality of users may be associated with a single residential service.

The first user may further access its residential service remotely with the electronic device 102E through a Public Access Point 106. In some embodiments, the public access point 106 may be located outside the residence of the first user and have an open access shared by multiple users (e.g. the access point may be located in a coffee shop, a library or any public location). In other embodiments, the public access point 106 may be located in a private location (e.g. the residence of the first user, the residence of the second user, work offices, etc.) and have an open access to the network that may be shared by multiple users. The unique APN associated with the residential service of the first user allows him to remotely access the residential service from the public access point 106. Further, when a residential subscriber (e.g. the first user) leaves the home, the home network is accessible using the unique Residential APN associated with its residential service. A subscriber may access this APN (i.e. the services associated with the APN) via Operator Public WiFi, Private WiFi, Mobile Networks or other Internet Accesses.

For devices connecting via Operator Public WiFi and/or a wired access point (e.g. with the Dynamic Host Configuration Protocol (DHCP)) a portal may be used to allow the individual (e.g. the first user connecting with its electronic device 102E through the public Access Point 106) to identify themselves and to associate a device (e.g. with its MAC address) with their residential service. In some embodiments, for devices not browser equipped, the operator can make a service portal available to the subscriber to associate devices to their service and to their associated unique APN. In some embodiments the subscriber may register a device using the service portal prior to accessing the residential service with the device. Once the device of the user is known the database can be updated and the unique APN can be associated with the device. Sign on the “next” time can be seamless and associated to the corresponding service/APN.

FIG. 1B illustrates a diagram of an exemplary virtual residential gateway in accordance with one embodiment. In this example, each home has a network device 120A, 130A which implements a network element providing Layer 2 functionalities (e.g. a L2 gateway device with WiFi capabilities). In some embodiments the network device may provide additional networking functionalities (e.g. Layer 3 functionalities). The network device (i.e. the home gateway device 120A or 130A) will tunnel back to a virtualized home gateway 150 of the operator core network (e.g. to a virtualized WLAN Access Gateway (vWAG) or virtualized Broadband Network Gateway (vBNG)) where Layer 3 services are hosted in a cloud execution environment running in a datacenter. All devices connecting to the virtual home gateway (150) will be associated with or attached to a unique residential APN. The virtualized home gateway 150 includes a database 140 of residential APNs, where each APN is associated with a residential service of a customer and allows the residential gateway to define the type of service provided to the user and the devices associated with the service. Attributes are defined in the authentication, authorization and accounting element (AAA) 150B to facilitate this attachment and can be inserted into existing access network call flows. Each residential APN is associated with a single residential service. For example as illustrated in FIG. 1B, the residence 102 is associated with the identifier “home1.operator.net” which is a unique APN identifier. This APN (APN1) determines the type of residential service established for the residence 102. The residence 130 is associated with APNx: “homex.operator.net” which is different from the APN identifier of the residence 102 and is unique to the residential service of the residence 130. For each APN, multiple electronic devices may be attached to it. For example, a customer establishing a residential service may have a laptop, a smartphone, a tablet, a desktop, printers, scanners, video surveillance cameras and many more electronic devices that will be associated to the unique residential APN. In these embodiments, each residence maintains a single routing and security domain through the unique APN associated with the residence. Once defined, a residential APN can then also use the different bearer characteristics associated with it (as is the case for its use in the mobile network) for example—a default bearer could be used for Internet Access and dedicated bearers for Voice and Video services. A home may have more than one APN associated to allow for further service differentiation. Additional home services e.g. smarthome services or residential security services may be assigned additional APNs such that these services are further segregated. Once a residential APN is active and devices are attached then network policies can be applied on a bearer level within a defined APN introducing the concept of residential Bearers. For example the policy network element 150A may be used to enforce a set of policy rules associated with the residential APN1 and further used to enforce a different set of policy rules associated with the residential APNx. For example the Policy network element 150A may be used to determine the set of policy rules associated with an APN.

FIG. 1C illustrates a diagram of a residential gateway for providing service differentiation to a user of a residential service in accordance with one embodiment. For each residential service, a unique residential APN is associated with the service and with multiple electronic devices belonging to the service subscriber. In some embodiments, once defined, a residential APN may use the different bearer characteristics associated with it. For example, as illustrated in FIG. 1C, a default bearer can be used for Internet Access, a first dedicated bearer may be used for Voice over IP applications and a third bearer may be used for video and audio streaming service. In one example, the electronic device 102D connects to the residential gateway via a wireless connection to the access point 120A and accesses the Internet through the default bearer of APN1. The electronic device 102C connects to the residential gateway 150 via a wireless connection to the access point 120A and uses a VoIP application through a first dedicated bearer of APN1. The electronic device 102B connects to the residential gateway via a wireless connection to the access point 120A and streams video and/or audio through a second dedicated bearer of APN1. Although only three services are illustrated with three bearers, multiple bearers may be used to provide as many differentiated services as desired by the user of the residential service.

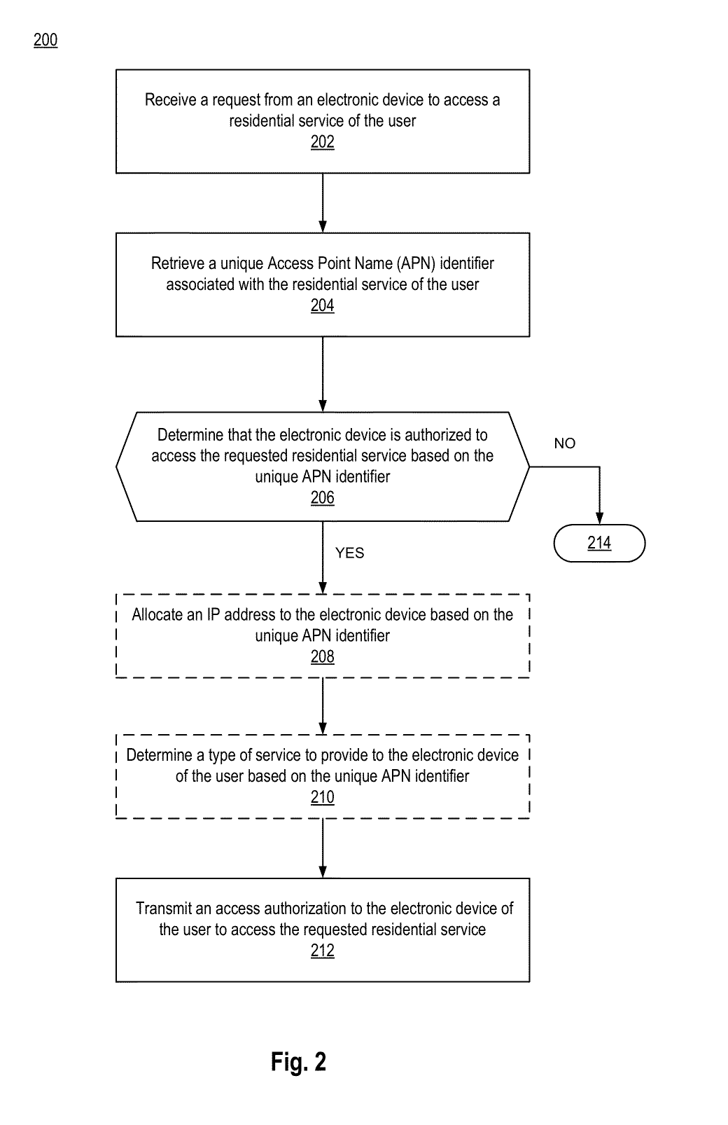

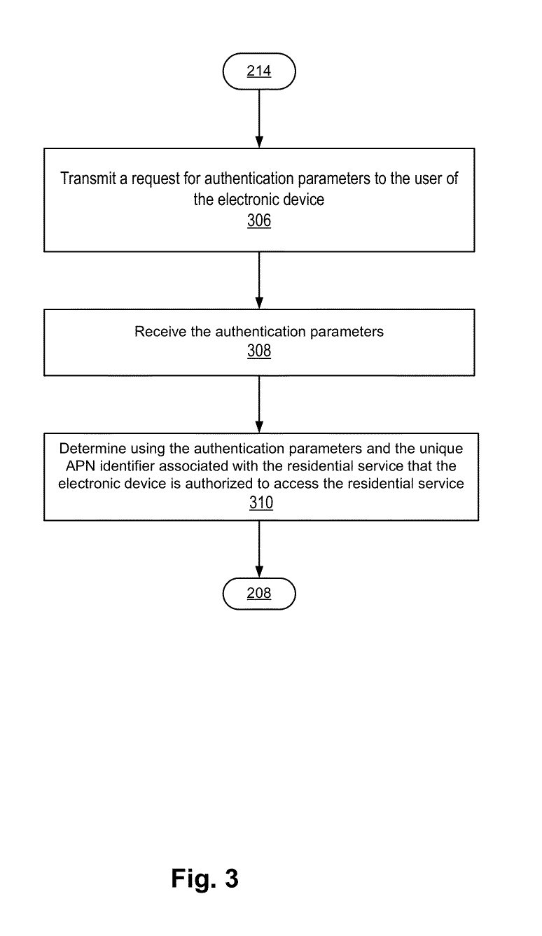

The operations in the flow diagrams of FIG. 2 and FIG. 3 will be described with reference to the exemplary embodiments of FIGS. 1A-C. However, it should be understood that the operations of the flow diagrams can be performed by embodiments of the invention other than those discussed with reference to FIGS. 1A-C, and the embodiments of the invention discussed with reference to FIGS. 1A-C can perform operations different than those discussed with reference to the flow diagrams.

FIG. 2 illustrates a flow diagram for delivering a residential service to electronic devices of a user over a network based on a unique APN associated with the residential service, in accordance with one embodiment. At block 202, a network device receives a request to access a residential service from an electronic device of a user. Referring to FIG. 1, in one embodiment, the residential gateway 108 receives a request (1.b) to access the residential service of the first user, from the electronic device 102B of the first user. In this example, the request is first transmitted (1.a) from the electronic device 102B to the access point 102A prior to being transmitted at operation (1.b) to the residential gateway 108. In other embodiments, the residential gateway 108, receives the request to access the residential service of the first user from the electronic device 102E, through the public access point 106. In another embodiment, the residential gateway 108 receives the request to access the residential service of the second user from the electronic device 104C or 104B of the second user and through the residential access point 102A or 104A respectively. In some embodiments, the request includes a unique identifier associated with the residential service of a user. The unique identifier included in the request uniquely identifies the residence of the user. For example, the unique identifier may be a unique alphanumerical value identifying the residence of the user which was allocated to the residence when the user signed up for a residential service. Alternatively, the unique identifier uniquely identifies the electronic device of the user. For example, the unique identifier may be the MAC address of the electronic device, the Mobile Station International Subscriber Directory Number (MSISDN or phone number) associated with the user, or International Mobile Subscriber Identity (IMSI) of the user, etc. In other embodiments, the unique identifier is the unique APN identifier associated with the residential service of the user. For example, if the electronic device of the user is 3GPP enabled and may be configured with the unique APN identifier of the residential service of the user. In some embodiments, the access point (102A, 106, or 104A) is a Layer 2 network device which tunnels back requests and packets to the residential gateway 108. In other embodiments, the access point is a Layer 3 network device which can forward a Layer 2 request to the residential gateway 108.

At block 204, the network device retrieves a unique Access Point Name (APN) associated with the residential service of the user. In some embodiments, where a unique identifier is included in the request, the unique identifier is a unique identifier of the residence. For example, the residence of the first user may be associated with a unique identifier e.g. “First residential ID.” In some embodiments, the first residential ID is configured in the access point 102A and is added by the access point 102A to each request received from the first user to be transmitted to the residential gateway 108. In other embodiments, the unique identifier may be a unique identifier associated with the electronic device (e.g. MAC address of the electronic device). In other embodiments, the unique identifier may include a unique identifier of the device and a unique identifier of the residence (e.g. MAC address and the residential ID). The unique identifier is used as a key to retrieve, at operation (2), the unique APN associated with the residential service. The residential gateway 108 includes a database of APN identifiers associated with the different residential services of the subscribers. The residential gateway 108, upon receipt from the first user of a request to access the network, accesses the database to retrieve the unique APN associated with the residential service of the first user. Flow moves to block 206.

At block 206, the network device determines that the electronic device is authorized to access the requested residential service based on the unique APN. In some embodiments, upon receipt of the request to access the residential service of the first user from the electronic devices 102B or 102E, the residential gateway 108 determines whether the electronic device (e.g. the electronic device 102B) is a registered device and is authorized to access the residential service of the first user. The authorization, at operation (3), is performed based on the unique APN associated with the residential service of the user. Each APN is associated with a list of electronic device identifiers with corresponding authorization parameters. Upon retrieval of the unique APN associated with the residential service, the residential gateway may further retrieve the list of devices and their corresponding authorization parameters to determine whether the device initiating the access request is authorized or not. If the electronic device is not determined to be authorized to access the residential service, flow moves to block 214. If the electronic device is determined to be authorized to access the residential service flow moves to block 208.

At block 208, the network device allocates an IP address to the electronic device based on the unique APN. In some embodiment, the unique APN is associated with a pool of IP addresses reserved for allocation to electronic devices associated with a residential service. For example, referring back to FIG. 1, for each unique APN, the residential gateway 108 has access to a pool of IP addresses that can be allocated to the electronic device 102B.

At block 210, the network device determines the type of service to provide to the electronic device of the user based on the unique APN. In one embodiment, the residential gateway 108 may retrieve service parameters associated with the unique APN. For example, the unique APN is used to retrieve quality of service (QoS) parameters, (e.g. which would allow traffic classification marking, traffic conditioning and scheduling), and security parameters (e.g., filters to protect customer premises from network—originated attacks, to avoid malformed route announcements). The unique APN enables the use of dedicated and default bearers for providing service differentiation and prioritization within the residential service offering. In some embodiments, the operations performed at block 208 and 210 are optional and upon determination that the electronic device is authorized to access the residential service at block 206, flow moves to block 212.

At block 212, the network device transmits an access authorization to the electronic device of the user to access the requested residential service. For example, the residential gateway 108 transmits, at operation (4) of FIG. 1A, an authorization to access the residential service of the first user to the residential access point 102A which forwards it to the electronic device 102B.

FIG. 3 illustrates a flow diagram for authorizing access to a residential service to an unregistered electronic device of a user. In some embodiments, upon determination at block 206 that the electronic device is not authorized to access the requested residential service, the network device may transmit a request for authentication to the user. At block 306 the request for authentication may include a redirection of the user to a web portal for providing authentication parameters. At block 308, the network device receives from the user authentication parameters (e.g. username and a password) and flow moves to block 310. At block 310, the network device determines with the authentication parameters and the unique residential APN that the electronic device is authorized to access the residential service. The network element may further update a database of authorized electronic devices with an identifier of the electronic device such that all future connections of this device to the residential service are seamless.

Accessing the Residential Service with a Known Device

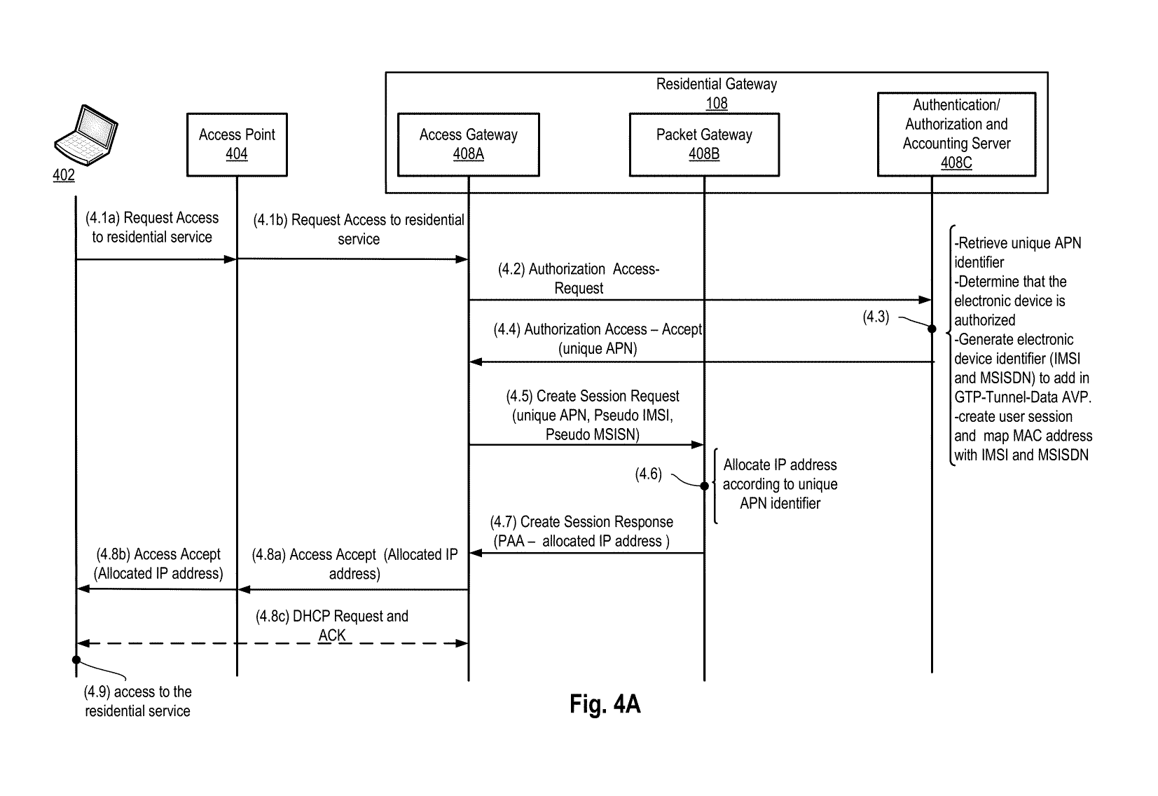

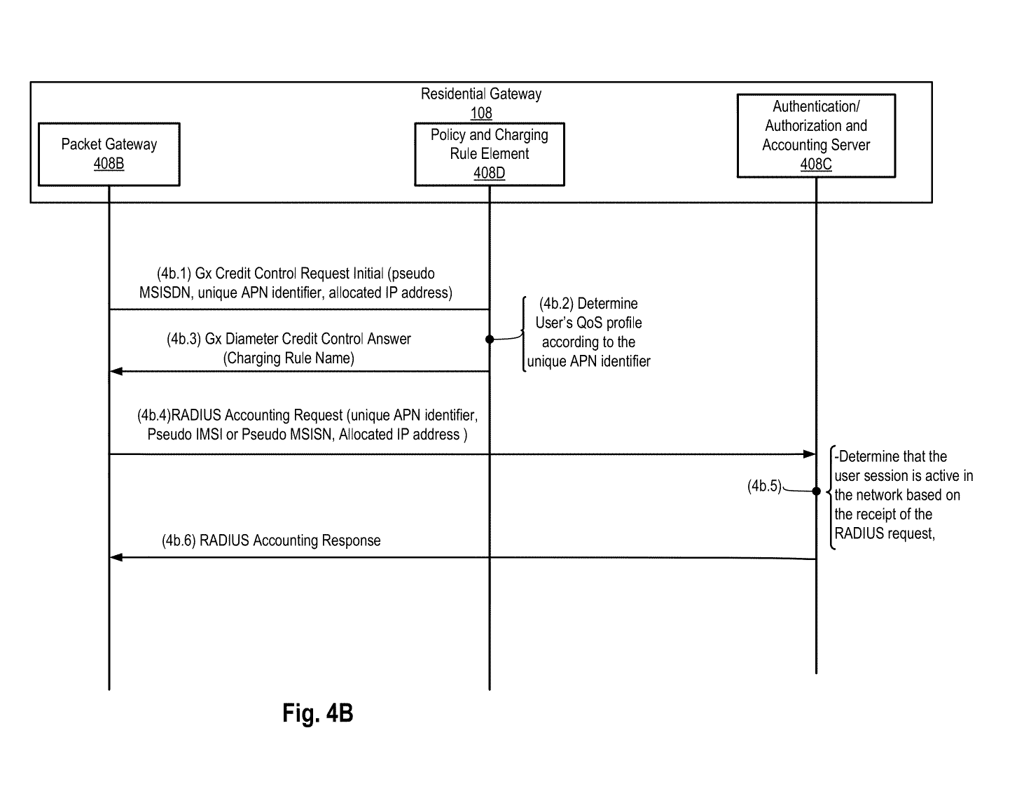

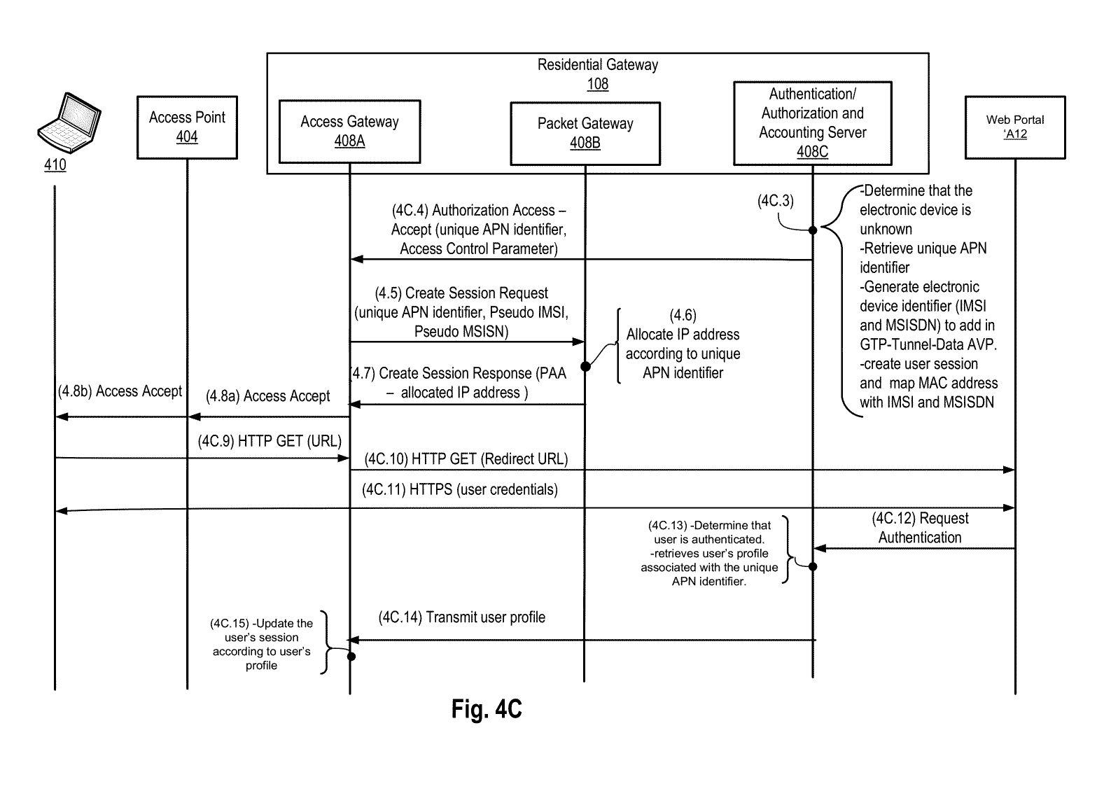

The operations in the exemplary flow diagrams of FIG. 4A-C will be described with reference to the exemplary embodiments of FIGS. 1A-C. However, it should be understood that the operations of the flow diagrams can be performed by embodiments of the invention other than those discussed with reference to FIGS. 1A-C, and the embodiments of the invention discussed with reference to FIGS. 1A-C can perform operations different than those discussed with reference to the flow diagrams of FIGS. 4A-C.

FIG. 4A illustrates an exemplary flow diagram of operations for providing access to a residential service based on a unique APN associated with the residential service in accordance with one embodiment. In the illustrated embodiment, the electronic device 402 is registered as part of a group of electronic devices associated with the residential service of the user. In some embodiments, the electric device 402 may have been previously registered and associated with the unique APN associated with the residential service of the user. In some embodiments, the registration process is performed according to operations described with reference to FIG. 3 and/or FIG. 4C (described herein below).

At operation (4.1a) a request to access the residential service is sent to the residential access point 404 from the electronic device 402. The electronic device 402 may be any of the electronic device 102B of the first user connecting through the access point 102A or the electronic device 104B of the second user connecting through the access points 104A. The connection between the access points and the electronic devices may be a wired (e.g. Ethernet, xDSL, xPON, FTTx, etc.) or wireless connection (e.g. WiFi). The request to access the residential service includes a unique identifier of the electronic device. In some embodiments the unique identifier of the electronic device (402) is the Media Access Control (MAC) address of the device. In one example, the request is a Dynamic Host Configuration Protocol (DHCP) Discovery operation and is used by the electronic device 404 to request Internet Protocol parameters, such as an IP address.

At operation (4.1b), the access point 404 transmits, to the residential gateway 108, the request to access the residential service. In some embodiments, the request is transmitted to the Access Gateway 408A included in the residential gateway 108. In some embodiments, the access point is a private access point associated with the user (e.g. the device 102B accessing through the residential access point 102A). In some embodiments, the access point is a public access point which is shared by multiple users to access a network of a service provider (e.g. the public access point 106). The public access point may be located within a private or a public location. In other embodiments, the access point is a private access point which is not associated with the user (e.g. the electronic device 104C accessing through the access point 102A).

In some embodiments, the access point 404 transmits with the request a unique identifier associated with the residential service of the user (e.g. residential ID). The residential ID is assigned to the residential service and the access point 404 when the residential service is established for the user. The residential ID is further associated with the unique APN defining the residential service of the user. In some embodiments, a user may have a plurality of residences and each residence is associated with the same residential service of the user. Each residence (i.e. access point within the residence) may be associated with a unique residential identifier. For example, if the user has two residences, the first residence is associated with residential ID1 and the second residence with residential ID2. In this embodiment, the residential service is associated with a unique APN which is in turn associated with residential ID1 and residential ID2. In some embodiments, the access point 404 is a Layer 2 network element (e.g. a Layer 2 Switch WiFi Access Point 120A or A130A of FIG. 1B) and the unique identifier is a tag added to each packet transmitted from the access point to the residential gateway 108. In some embodiments, the Access Gateway 408A is a Trusted Wireless Access Gateway (TWAG) in the WiFi core. The TWAG is connected directly with a Packet Gateway in the Evolved Packet Core (EPC) through a secure tunnel (GTP, MIP or PMIP). In one example, the request is a DHCP Discovery operation and is transmitted from the Access point to the access gateway 408A to request Internet Protocol parameters, such as an IP address for the electronic device 402.

At operation (4.2), an Access Authorization Request is transmitted to the authentication authorization and accounting (AAA) element 408C. In some embodiments, the Access authorization request is a Remote Authentication Dial In User Service (RADIUS) Access-Request with the following attributes (User-Name—(MAC Address), Acct-Session-Id (MAC Address), NAS-IP-Address (Access Gateway IP Address)) sent by the access gateway 408A to the AAA server 408C.

At operation (4.3), the AAA server 408C determines that the electronic device 402 is authorized to access the requested residential service. The AAA server 408C is configured to determine the unique APN associated with the residential service of the electronic device 402 and configured to retrieve the unique APN. In some embodiments, the unique APN is retrieved based on the unique residence identifier (i.e. residential ID) transmitted from the access point 404. In another embodiment, the unique APN is retrieved based on the unique identifier of the electronic device (e.g. MAC address of the electronic device) transmitted through the Access point 404. In one exemplary embodiment, the AAA server receives the MAC address of the electronic device 402 and determines which unique APN is associated with the device. In some embodiments, the user may have registered each of their devices with the residential service, thus associating each MAC address of the devices with the unique residential APN. In some embodiments, the AAA server 408C further generates a pseudo identifier for the electronic device (e.g. a pseudo International Mobile Subscriber Identity (IMSI) and a pseudo Mobile Station International Subscriber Directory Number (MSISDN)) to be transmitted to the Access Gateway 408A. Further the AAA creates a user session and maps the electronic device identifier (i.e. the MAC address of the electronic device) with the pseudo identifier(s) of the electronic device (e.g. the generated pseudo IMSI and the generated pseudo MSISDN). In some embodiments, the AAA server 408C adds the unique APN and the generated pseudo identifier(s) (e.g. IMSI and MSISDN) in a GPRS Tunneling Protocol (GTP) header (e.g. GTP-Tunnel-Data AVP) along with other attributes.

At operation (4.4) the AAA server 408C transmits an authorization access accept message to the access gateway 408A including the unique APN. In some embodiments, the message transmitted by the AAA server is a RADIUS Access Accept including the unique APN associated with the residential service of the user.

At operation (4.5), the access gateway 408A requests the creation of a session for the user. In some embodiments, the session is based on the unique APN and the generated pseudo IMSI and pseudo MSISDN. In one embodiment, the “Create Session Request” message is transmitted including the attributes: unique APN defining the residential service of the user, a pseudo IMSI assigned to the electronic device, and a pseudo MSISDN assigned to the electronic device 402 even if the electronic device is a non-3GPP device. The Create Session Request is transmitted to the Packet Gateway 408B. In some embodiments, the Packet Gateway includes a Packet Data Network (PDN) Gateway of an Evolved Packet Core (EPC) and provides connectivity from the electronic device of the user to external packet data networks by being the point of exit and entry of traffic for the electronic device to and from external networks (such as the Internet). The packet gateway performs policy enforcement, packet filtering for each user, charging support, lawful interception and packet screening according to the unique APN associated with the residential service of the user.

At operation (4.6) upon receipt of the Create Session Request message, the packet gateway 408B, allocates an IP address for the electronic device based on the unique APN associated with the residential service of the user. In some embodiments the packet gateway 408B includes an internal pool of IP addresses associated with each unique APN. The pool of addresses is accessed to assign an IP address to the electronic device. In some embodiments, the address is allocated randomly to the electronic device. In other embodiments, the IP address is allocated according to a mapping technique (e.g. hashing function, a round-robin mapping, etc.). In another embodiment, the Packet Gateway may allocate the IP address through a request transmitted to another network element such as a Dynamic Host Configuration Protocol DHCP server.

In some embodiments, the packet gateway 408B may perform additional operations, following the allocation of the IP address to the electronic device 402 and prior to transmitting a response to the create session request message. In some embodiments, the additional operations are performed according to the operations illustrated in FIG. 4B and enable the residential gateway to set up a billing scheme and service parameters corresponding to the user's residential service. FIG. 4B illustrates an exemplary flow diagram of operations for determining a charging policy for the user according to a unique APN associated with its residential service. The subscription of the user is determined by the parameters associated with the unique APN of its residential service. Thus, in some embodiments, at operation (4b.1), the unique APN is transmitted to a Policy and Charging Rule Element 408D of the residential gateway with a request for determining a charging rule associated with the user's subscription. In some embodiments, the packet gateway 408B transmits a Gx Credit Control Request Initial message including the pseudo MSISDN generated for the electronic device 402, the allocated IP address, and the unique APN associated with the residential service of the user. The request may include further attributes. At operation (4b.2), the policy and charging rule element 408D determines the Quality of Service (QoS) profile of the user associated with the unique APN. At operation (4b.3), the policy and charging rule element 408D transmits a response to the packet gateway 408B including the name of the charging rule associated with the residential service of the user. At operation (4b.4) the packet gateway 408B transmits an accounting request (e.g. RADIUS Account Request including the unique APN, the allocated IP address and a pseudo electronic device identifier (IMSI or MSISDN)) to the AAA server 408C. The AAA server 408C determines, at operation (4b.5) that the user's session is active in the network based on the receipt of the Accounting Request. At operation (4b.6) the AAA server 408C transmits an Accounting Response (e.g. RADIUS Accounting Response) and flow moves to operation (4.7) of FIG. 4A. In some embodiments, the operations described with reference to FIG. 4B are skipped and following the operation (4.6) of FIG. 4A, flow moves to operation (4.7).

At operation (4.7) the Packet Gateway 408B transmits create session response to the access gateway 408A. The session response includes the allocated IP address for the electronic device 402 of the user.

At operation (4.8a), the Access Gateway 408A transmits an access accept message to the access point 404. At operation (4.8b) the access point 404 forwards the access accept message to the electronic device 402. In some embodiments, the operation at (4.8a) includes transmitting a DHCP offer and forwarding the DHCP offer at operation (4.8b) to the electronic device 402. In these embodiments, the electronic device 402 and the access gateway 408 may exchange further messages prior to providing access to the residential service. For example, operation(s) (4.8c) may be performed and a DHCP request and a DHCP acknowledgment are transmitted.

At operation (4.9) the electronic device is provided access to the residential service for which the user has subscribed. For example the user may use the electronic device to surf the Internet, use a Voice over IP application, or stream video or audio, etc. In another example, the user may use the device to connect to their residential network through a remote access point (e.g. connect through a public network and print documents on a printer at their residence).

Accessing the Residential Service with an Unknown Device

FIG. 4C illustrates an exemplary flow diagram of operations for providing access to a residential service of an unregistered electronic device in accordance with one embodiment. In some embodiments, the subscriber of the residential service may attempt to access the service with an unregistered electronic device. For example, the user may attempt a sign on (i.e. access to the residential service) with a device of an unknown MAC address. In some embodiments, the access gateway (e.g. a WiFi Gateway) acts as a proxy for the device and the Authentication, Authorization and Accounting (AAA) server returns 3GPP attributes needed for the creation of a session (e.g. attributes needed for a S2a “create session”) to the Packet Gateway (PGW). In one embodiment, the electronic device 410 is unknown to the residential gateway and is attempting to access the residential service of the subscriber through the Access Point 404. In this embodiment, operations (4.1a), (4.1b), and (4.2) are first performed in accordance with embodiments described with regards to FIG. 4A. These operations are not illustrated in FIG. 4C. Following operation (4.2), the AAA 408C determines that the electronic device is unknown (e.g. the MAC address of the electronic device is unregistered with the residential service of the subscriber), however the AAA server is configured to allow unknown devices to attempt to connect to the residential service. In these embodiments, the AAA checks the source IP address to determine which access gateway transmitted the request and transmits an access control parameter to the access gateway. The access control parameter forces redirection of all traffic from the electronic device to a web portal for authentication and identification of the user. At operation (4C.9) the electronic device transmits a HTTP get to access a webpage, upon receipt of the request, the Access Gateway redirects the request to a web portal for the user to enter its credential associated with the residential service. At operation(s) (4c.11) the user enters its credentials. For example, the user may be requested to enter a username and a password associated with their residential service (i.e. associated with the unique APN of the residential service). At operation (4C.12), the web portal transmits the user's credentials to the AAA server with a request for authentication. At operation (4C.13) the AAA server determines that the user is authenticated and is associated with the unique APN of the requested residential service. The AAA server retrieves the user's profile defined with the APN. For example, once portal authentication/identification takes place, AAA issues a CoA to update the service. At operation (4C.14), the AAA server 408C determines that the user is authorized to access the residential service based on the credentials entered through the web portal and the unique APN associated with the residential service of the user. The AAA server further retrieves the profile and service type associated with the user. At operation (4C.14), the user's profile is transmitted to the access gateway. The access gateway 408A updates the user's session according to the user's profile and provides access to the electronic device 410.

The concept of assigning a unique Residential APN to the residence or service construct allows for a natural grouping and managing the service and corresponding QoS/IP addressing. This concept does not preclude the use of multiple APNs per one residential Gateway (GW) or on-ramp. Multiple APNs could be used to meet the needs of multiple service instances. In some embodiments, different unrelated people sharing a residence, may require separate billing and are therefore assigned different unique APNs.

In another exemplary embodiment, a “friend” visiting the residence of a user (e.g. as illustrated in FIG. 1, a friend with device 104C is visiting the first user and attempts to access their own residential service through the access point 102A) and his device is known to the system, the device is automatically routed to its “home” APN and has all the access and benefits as if they were at their “base” residence. For example, upon connection to the access point 102A, the request to connect is transmitted to the Residential Gateway 108 which identifies the unique APN associated with the residential service of the second user. The unique APN is used to establish access to the residential service of the second user (Internet Access, access to the residential network of the second user, VoIP, etc.). In this example, even though the second user is connecting through a private access point associated with the residential service of the first user, the second user is able to connect to their own residential service and be billed accordingly.

In some embodiments, a unique public APN may be defined such that electronic devices may receive services within the context of a public APN. The public APN has a default set of bearers and QoS profiles in order to deliver pre-defined services. This allows for example for “inbound data roaming” of non-subscribers where they are ‘quarantined’ and can receive services within the context of a public APN.

In another embodiment, in the case of accessing the residential APN through a mobile network (e.g. the Public Access Point 106 may be an access point of a mobile network)—The Residential Network owner may have a business relationship with the mobile operator such that the mobile operator carries the unique APN natively meaning that a subscriber can access their Residential APN directly. In other cases the user can be forced through a portal to authenticate and connect to their associated residential service based on the unique APN as described with reference to FIG. 4C.

In another embodiment, in a public/carrier WiFi offering, assuming that the carrier WiFi network is operated by the same operator providing the residential service or by an operator with a roaming partner agreement then the public/carrier WiFi network would already have the user credentials provisioned as well as the Residential APN defined in the terminating Gateway. In other words, the terminating Gateway of the network would be configured to include a residential Gateway as described with reference to FIGS. 1A-C and FIGS. 4A-C.

Embodiments of the invention enable seamless mobility of services inside and outside a residence of a subscriber (i.e. the user of a residential service). For example, with a unique residential APN associated to each residential service, a roaming framework can be provided such that subscriber may access their residential service through a mobile network and/or a fixed network.

Embodiments of the invention provide a method of delivering a residential service to an electronic device of a user over a network. The method includes receiving a request from an electronic device of the user to access a residential service associated with the user; retrieving a unique Access Point Name (APN) identifier associated with the residential service of the user. The method further includes determining that the electronic device is authorized to access the requested residential service based on the unique APN identifier associated with the residential service of the user; and responsive to the determination, transmitting an access authorization for the electronic device of the user to access the requested residential service.

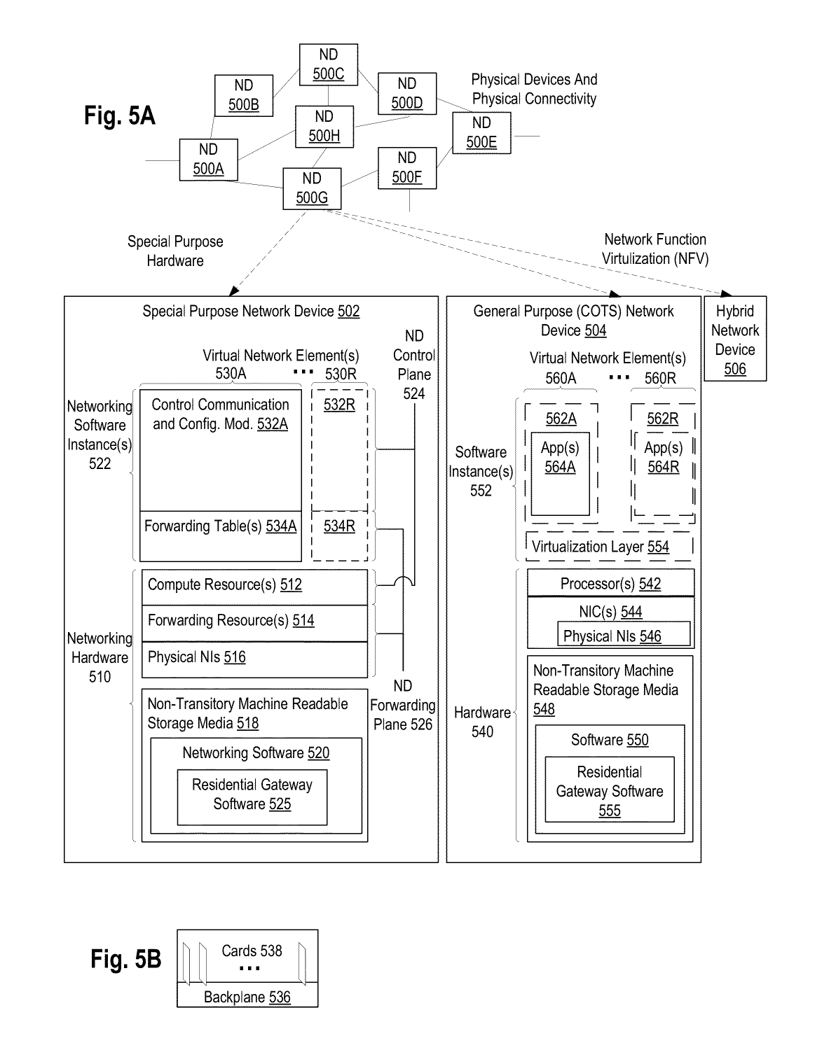

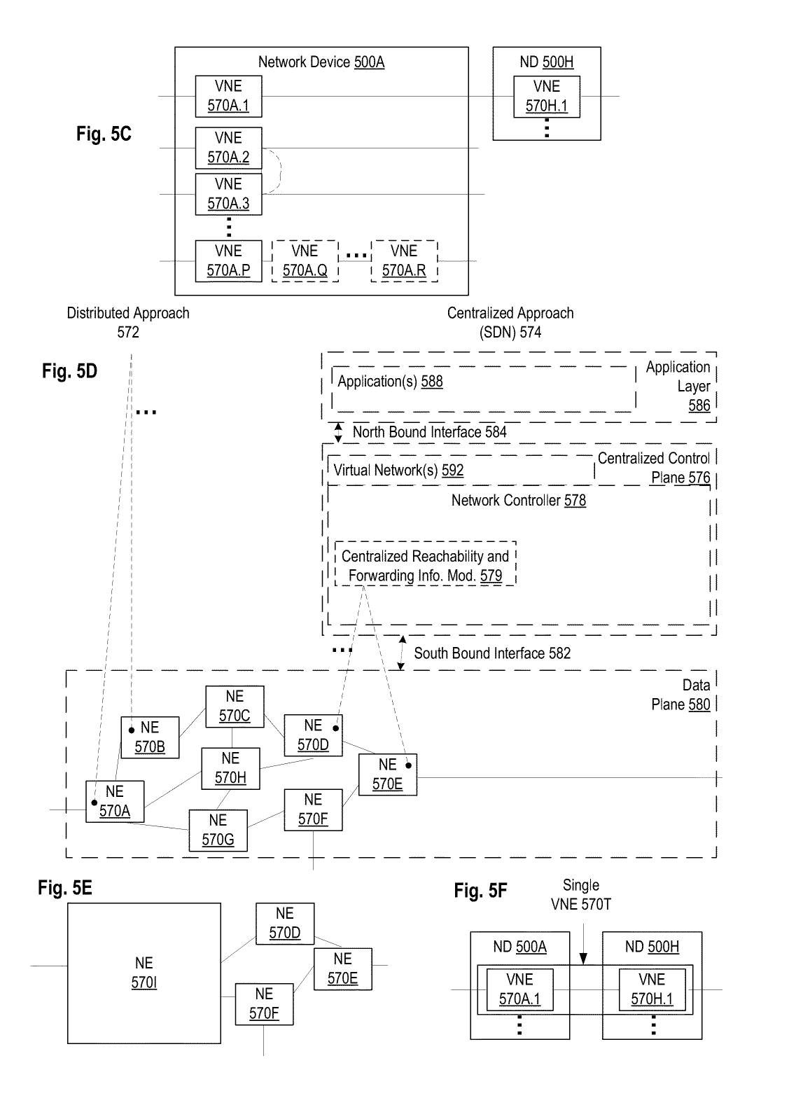

Embodiments of the invention, in particular the residential gateway described with reference to FIGS. 1A-C and FIGS. 4A-C may be implemented as a network device within a network. The network device may include one or more network elements performing the tasks described with reference to FIG. 2, FIG. 3 and FIGS. 4A-C. The network device and network elements may be implemented as described with respect to embodiments of the FIGS. 5A-F as described herein below.

FIG. 5A illustrates connectivity between network devices (NDs) within an exemplary network, as well as three exemplary implementations of the NDs, according to some embodiments of the invention. FIG. 5A shows NDs 500A-H, and their connectivity by way of lines between A-B, B-C, C-D, D-E, E-F, F-G, and A-G, as well as between H and each of A, C, D, and G. These NDs are physical devices, and the connectivity between these NDs can be wireless or wired (often referred to as a link). An additional line extending from NDs 500A, E, and F illustrates that these NDs act as ingress and egress points for the network (and thus, these NDs are sometimes referred to as edge NDs; while the other NDs may be called core NDs).

Two of the exemplary ND implementations in FIG. 5A are: 1) a special-purpose network device 502 that uses custom application-specific integrated-circuits (ASICs) and a proprietary operating system (OS); and 2) a general purpose network device 504 that uses common off-the-shelf (COTS) processors and a standard OS.

The special-purpose network device 502 includes networking hardware 510 comprising compute resource(s) 512 (which typically include a set of one or more processors), forwarding resource(s) 514 (which typically include one or more ASICs and/or network processors), and physical network interfaces (NIs) 516 (sometimes called physical ports), as well as non-transitory machine readable storage media 518 having stored therein networking software 520. A physical NI is hardware in a ND through which a network connection (e.g., wirelessly through a wireless network interface controller (WNIC) or through plugging in a cable to a physical port connected to a network interface controller (NIC)) is made, such as those shown by the connectivity between NDs 500A-H. In some embodiments, the networking software 520 may include the Residential Gateway Software (RGS) 525 which is adapted to perform operations described with regards to FIGS. 2-3, and FIGS. 4A-C. During operation, the networking software 520, and in particular the RGS 525 may be executed by the networking hardware 510 to instantiate a set of one or more networking software instance(s) 522. Each of the networking software instance(s) 522, and that part of the networking hardware 510 that executes that network software instance (be it hardware dedicated to that networking software instance and/or time slices of hardware temporally shared by that networking software instance with others of the networking software instance(s) 522), form a separate virtual network element 530A-R. Each of the virtual network element(s) (VNEs) 530A-R includes a control communication and configuration module 532A-R (sometimes referred to as a local control module or control communication module) and forwarding table(s) 534A-R, such that a given virtual network element (e.g., 530A) includes the control communication and configuration module (e.g., 532A), a set of one or more forwarding table(s) (e.g., 534A), and that portion of the networking hardware 510 that executes the virtual network element (e.g., 530A).

The special-purpose network device 502 is often physically and/or logically considered to include: 1) a ND control plane 524 (sometimes referred to as a control plane) comprising the compute resource(s) 512 that execute the control communication and configuration module(s) 532A-R; and 2) a ND forwarding plane 526 (sometimes referred to as a forwarding plane, a data plane, or a media plane) comprising the forwarding resource(s) 514 that utilize the forwarding table(s) 534A-R and the physical NIs 516. By way of example, where the ND is a router (or is implementing routing functionality), the ND control plane 524 (the compute resource(s) 512 executing the control communication and configuration module(s) 532A-R) is typically responsible for participating in controlling how data (e.g., packets) is to be routed (e.g., the next hop for the data and the outgoing physical NI for that data) and storing that routing information in the forwarding table(s) 534A-R, and the ND forwarding plane 526 is responsible for receiving that data on the physical NIs 516 and forwarding that data out the appropriate ones of the physical NIs 516 based on the forwarding table(s) 534A-R.

FIG. 5B illustrates an exemplary way to implement the special-purpose network device 502 according to some embodiments of the invention. FIG. 5B shows a special-purpose network device including cards 538 (typically hot pluggable). While in some embodiments the cards 538 are of two types (one or more that operate as the ND forwarding plane 526 (sometimes called line cards), and one or more that operate to implement the ND control plane 524 (sometimes called control cards)), alternative embodiments may combine functionality onto a single card and/or include additional card types (e.g., one additional type of card is called a service card, resource card, or multi-application card). A service card can provide specialized processing (e.g., Layer 4 to Layer 7 services (e.g., firewall, Internet Protocol Security (IPsec) (RFC 4301 and 4309), Secure Sockets Layer (SSL)/Transport Layer Security (TLS), Intrusion Detection System (IDS), peer-to-peer (P2P), Voice over IP (VoIP) Session Border Controller, Mobile Wireless Gateways (Gateway General Packet Radio Service (GPRS) Support Node (GGSN), Evolved Packet Core (EPC) Gateway)). By way of example, a service card may be used to terminate IPsec tunnels and execute the attendant authentication and encryption algorithms. These cards are coupled together through one or more interconnect mechanisms illustrated as backplane 536 (e.g., a first full mesh coupling the line cards and a second full mesh coupling all of the cards).

Returning to FIG. 5A, the general purpose network device 504 includes hardware 540 comprising a set of one or more processor(s) 542 (which are often COTS processors) and network interface controller(s) 544 (NICs; also known as network interface cards) (which include physical NIs 546), as well as non-transitory machine readable storage media 548 having stored therein software 550 including the Residential Gateway Software 555. During operation, the processor(s) 542 execute the software 550 including the Residential Gateway Software 555 to instantiate one or more sets of one or more applications 564A-R. While one embodiment does not implement virtualization, alternative embodiments may use different forms of virtualization—represented by a virtualization layer 554 and software containers 562A-R. For example, one such alternative embodiment implements operating system-level virtualization, in which case the virtualization layer 554 represents the kernel of an operating system (or a shim executing on a base operating system) that allows for the creation of multiple software containers 562A-R that may each be used to execute one of the sets of applications 564A-R. In this embodiment, the multiple software containers 562A-R (also called virtualization engines, virtual private servers, or jails) are each a user space instance (typically a virtual memory space); these user space instances are separate from each other and separate from the kernel space in which the operating system is run; the set of applications running in a given user space, unless explicitly allowed, cannot access the memory of the other processes. Another such alternative embodiment implements full virtualization, in which case: 1) the virtualization layer 554 represents a hypervisor (sometimes referred to as a virtual machine monitor (VMM)) or a hypervisor executing on top of a host operating system; and 2) the software containers 562A-R each represent a tightly isolated form of software container called a virtual machine that is run by the hypervisor and may include a guest operating system. A virtual machine is a software implementation of a physical machine that runs programs as if they were executing on a physical, non-virtualized machine; and applications generally do not know they are running on a virtual machine as opposed to running on a “bare metal” host electronic device, though some systems provide para-virtualization which allows an operating system or application to be aware of the presence of virtualization for optimization purposes. In some embodiments, each of the Instances 552 is adapted to perform the operations described with respect to FIGS. 2-3, and FIGS. 4A-C.

The instantiation of the one or more sets of one or more applications 564A-R, as well as the virtualization layer 554 and software containers 562A-R if implemented, are collectively referred to as software instance(s) 552. Each set of applications 564A-R, corresponding software container 562A-R if implemented, and that part of the hardware 540 that executes them (be it hardware dedicated to that execution and/or time slices of hardware temporally shared by software containers 562A-R), forms a separate virtual network element(s) 560A-R.

The virtual network element(s) 560A-R perform similar functionality to the virtual network element(s) 530A-R—e.g., similar to the control communication and configuration module(s) 532A and forwarding table(s) 534A (this virtualization of the hardware 540 is sometimes referred to as network function virtualization (NFV)). Thus, NFV may be used to consolidate many network equipment types onto industry standard high volume server hardware, physical switches, and physical storage, which could be located in Data centers, NDs, and customer premise equipment (CPE). However, different embodiments of the invention may implement one or more of the software container(s) 562A-R differently. For example, while embodiments of the invention are illustrated with each software container 562A-R corresponding to one VNE 560A-R, alternative embodiments may implement this correspondence at a finer level granularity (e.g., line card virtual machines virtualize line cards, control card virtual machine virtualize control cards, etc.); it should be understood that the techniques described herein with reference to a correspondence of software containers 562A-R to VNEs also apply to embodiments where such a finer level of granularity is used.

In certain embodiments, the virtualization layer 554 includes a virtual switch that provides similar forwarding services as a physical Ethernet switch. Specifically, this virtual switch forwards traffic between software containers 562A-R and the NIC(s) 544, as well as optionally between the software containers 562A-R; in addition, this virtual switch may enforce network isolation between the VNEs 560A-R that by policy are not permitted to communicate with each other (e.g., by honoring virtual local area networks (VLANs)).

The third exemplary ND implementation in FIG. 5A is a hybrid network device 506, which includes both custom ASICs/proprietary OS and COTS processors/standard OS in a single ND or a single card within an ND. In certain embodiments of such a hybrid network device, a platform VM (i.e., a VM that that implements the functionality of the special-purpose network device 502) could provide for para-virtualization to the networking hardware present in the hybrid network device 506.

Regardless of the above exemplary implementations of an ND, when a single one of multiple VNEs implemented by an ND is being considered (e.g., only one of the VNEs is part of a given virtual network) or where only a single VNE is currently being implemented by an ND, the shortened term network element (NE) is sometimes used to refer to that VNE. Also in all of the above exemplary implementations, each of the VNEs (e.g., VNE(s) 530A-R, VNEs 560A-R, and those in the hybrid network device 506) receives data on the physical NIs (e.g., 516, 546) and forwards that data out the appropriate ones of the physical NIs (e.g., 516, 546). For example, a VNE implementing IP router functionality forwards IP packets on the basis of some of the IP header information in the IP packet; where IP header information includes source IP address, destination IP address, source port, destination port (where “source port” and “destination port” refer herein to protocol ports, as opposed to physical ports of a ND), transport protocol (e.g., user datagram protocol (UDP) (RFC 768, 2460, 2675, 4113, and 5405), Transmission Control Protocol (TCP) (RFC 793 and 1180), and differentiated services (DSCP) values (RFC 2474, 2475, 2597, 2983, 3086, 3140, 3246, 3247, 3260, 4594, 5865, 3289, 3290, and 3317).

FIG. 5C illustrates various exemplary ways in which VNEs may be coupled according to some embodiments of the invention. FIG. 5C shows VNEs 570A.1-570A.P (and optionally VNEs 570A.Q-570A.R) implemented in ND 500A and VNE 570H.1 in ND 500H. In FIG. 5C, VNEs 570A.1-P are separate from each other in the sense that they can receive packets from outside ND 500A and forward packets outside of ND 500A; VNE 570A.1 is coupled with VNE 570H.1, and thus they communicate packets between their respective NDs; VNE 570A.2-570A.3 may optionally forward packets between themselves without forwarding them outside of the ND 500A; and VNE 570A.P may optionally be the first in a chain of VNEs that includes VNE 570A.Q followed by VNE 570A.R (this is sometimes referred to as dynamic service chaining, where each of the VNEs in the series of VNEs provides a different service—e.g., one or more layer 4-7 network services). While FIG. 5C illustrates various exemplary relationships between the VNEs, alternative embodiments may support other relationships (e.g., more/fewer VNEs, more/fewer dynamic service chains, multiple different dynamic service chains with some common VNEs and some different VNEs). In some embodiments, the residential gateway may be implemented as a ND including a VNE (e.g., VNE(s) 530A-R, VNEs 560A-R, and those in the hybrid network device 506) for enabling access to a user to their residential service based on a unique residential APN. In some embodiments, the residential gateway may be implemented as multiple VNEs coupled so they can communicate packets between themselves. For example, the residential gateway of FIGS. 1-4C may include an access gateway, an AAA server, a packet gateway, and a policy and charging rule element. Each element may include a VNE and can be coupled with one or more other elements from the residential gateway.

The NDs of FIG. 5A, for example, may form part of the Internet or a private network; and other electronic devices (not shown; such as end user devices including workstations, laptops, netbooks, tablets, palm tops, mobile phones, smartphones, phablets, multimedia phones, Voice Over Internet Protocol (VOIP) phones, terminals, portable media players, GPS units, wearable devices, gaming systems, set-top boxes, Internet enabled household appliances) may be coupled to the network (directly or through other networks such as access networks) to communicate over the network (e.g., the Internet or virtual private networks (VPNs) overlaid on (e.g., tunneled through) the Internet) with each other (directly or through servers) and/or access content and/or services. Such content and/or services are typically provided by one or more servers (not shown) belonging to a service/content provider or one or more end user devices (not shown) participating in a peer-to-peer (P2P) service, and may include, for example, public webpages (e.g., free content, store fronts, search services), private webpages (e.g., username/password accessed webpages providing email services), and/or corporate networks over VPNs. For instance, end user devices may be coupled (e.g., through customer premise equipment coupled to an access network (wired or wirelessly)) to edge NDs, which are coupled (e.g., through one or more core NDs) to other edge NDs, which are coupled to electronic devices acting as servers. However, through compute and storage virtualization, one or more of the electronic devices operating as the NDs in FIG. 5A may also host one or more such servers (e.g., in the case of the general purpose network device 504, one or more of the software containers 562A-R may operate as servers; the same would be true for the hybrid network device 506; in the case of the special-purpose network device 502, one or more such servers could also be run on a virtualization layer executed by the compute resource(s) 512); in which case the servers are said to be co-located with the VNEs of that ND.

A virtual network is a logical abstraction of a physical network (such as that in FIG. 5A) that provides network services (e.g., L2 and/or L3 services). A virtual network can be implemented as an overlay network (sometimes referred to as a network virtualization overlay) that provides network services (e.g., layer 2 (L2, data link layer) and/or layer 3 (L3, network layer) services) over an underlay network (e.g., an L3 network, such as an Internet Protocol (IP) network that uses tunnels (e.g., generic routing encapsulation (GRE), layer 2 tunneling protocol (L2TP), IPSec) to create the overlay network).

A network virtualization edge (NVE) sits at the edge of the underlay network and participates in implementing the network virtualization; the network-facing side of the NVE uses the underlay network to tunnel frames to and from other NVEs; the outward-facing side of the NVE sends and receives data to and from systems outside the network. A virtual network instance (VNI) is a specific instance of a virtual network on a NVE (e.g., a NE/VNE on an ND, a part of a NE/VNE on a ND where that NE/VNE is divided into multiple VNEs through emulation); one or more VNIs can be instantiated on an NVE (e.g., as different VNEs on an ND). A virtual access point (VAP) is a logical connection point on the NVE for connecting external systems to a virtual network; a VAP can be physical or virtual ports identified through logical interface identifiers (e.g., a VLAN ID).

Examples of network services include: 1) an Ethernet LAN emulation service (an Ethernet-based multipoint service similar to an Internet Engineering Task Force (IETF) Multiprotocol Label Switching (MPLS) or Ethernet VPN (EVPN) service) in which external systems are interconnected across the network by a LAN environment over the underlay network (e.g., an NVE provides separate L2 VNIs (virtual switching instances) for different such virtual networks, and L3 (e.g., IP/MPLS) tunneling encapsulation across the underlay network); and 2) a virtualized IP forwarding service (similar to IETF IP VPN (e.g., Border Gateway Protocol (BGP)/MPLS IPVPN RFC 4364) from a service definition perspective) in which external systems are interconnected across the network by an L3 environment over the underlay network (e.g., an NVE provides separate L3 VNIs (forwarding and routing instances) for different such virtual networks, and L3 (e.g., IP/MPLS) tunneling encapsulation across the underlay network)). Network services may also include quality of service capabilities (e.g., traffic classification marking, traffic conditioning and scheduling), security capabilities (e.g., filters to protect customer premises from network—originated attacks, to avoid malformed route announcements), and management capabilities (e.g., full detection and processing).

FIG. 5D illustrates a network with a single network element on each of the NDs of FIG. 5A, and within this straight forward approach contrasts a traditional distributed approach (commonly used by traditional routers) with a centralized approach for maintaining reachability and forwarding information (also called network control), according to some embodiments of the invention. Specifically, FIG. 5D illustrates network elements (NEs) 570A-H with the same connectivity as the NDs 500A-H of FIG. 5A.

FIG. 5D illustrates that the distributed approach 572 distributes responsibility for generating the reachability and forwarding information across the NEs 570A-H; in other words, the process of neighbor discovery and topology discovery is distributed.

For example, where the special-purpose network device 502 is used, the control communication and configuration module(s) 532A-R of the ND control plane 524 typically include a reachability and forwarding information module to implement one or more routing protocols (e.g., an exterior gateway protocol such as Border Gateway Protocol (BGP) (RFC 4271), Interior Gateway Protocol(s) (IGP) (e.g., Open Shortest Path First (OSPF) (RFC 2328 and 5340), Intermediate System to Intermediate System (IS-IS) (RFC 1142), Routing Information Protocol (RIP) (version 1 RFC 1058, version 2 RFC 2453, and next generation RFC 2080)), Label Distribution Protocol (LDP) (RFC 5036), Resource Reservation Protocol (RSVP) (RFC 2205, 2210, 2211, 2212, as well as RSVP-Traffic Engineering (TE): Extensions to RSVP for LSP Tunnels RFC 3209, Generalized Multi-Protocol Label Switching (GMPLS) Signaling RSVP-TE RFC 3473, RFC 3936, 4495, and 4558)) that communicate with other NEs to exchange routes, and then selects those routes based on one or more routing metrics. Thus, the NEs 570A-H (e.g., the compute resource(s) 512 executing the control communication and configuration module(s) 532A-R) perform their responsibility for participating in controlling how data (e.g., packets) is to be routed (e.g., the next hop for the data and the outgoing physical NI for that data) by distributively determining the reachability within the network and calculating their respective forwarding information. Routes and adjacencies are stored in one or more routing structures (e.g., Routing Information Base (RIB), Label Information Base (LIB), one or more adjacency structures) on the ND control plane 524. The ND control plane 524 programs the ND forwarding plane 526 with information (e.g., adjacency and route information) based on the routing structure(s). For example, the ND control plane 524 programs the adjacency and route information into one or more forwarding table(s) 534A-R (e.g., Forwarding Information Base (FIB), Label Forwarding Information Base (LFIB), and one or more adjacency structures) on the ND forwarding plane 526. For layer 2 forwarding, the ND can store one or more bridging tables that are used to forward data based on the layer 2 information in that data. While the above example uses the special-purpose network device 502, the same distributed approach 572 can be implemented on the general purpose network device 504 and the hybrid network device 506.

FIG. 5D illustrates that a centralized approach 574 (also known as software defined networking (SDN)) that decouples the system that makes decisions about where traffic is sent from the underlying systems that forwards traffic to the selected destination. The illustrated centralized approach 574 has the responsibility for the generation of reachability and forwarding information in a centralized control plane 576 (sometimes referred to as a SDN control module, controller, network controller, OpenFlow controller, SDN controller, control plane node, network virtualization authority, or management control entity), and thus the process of neighbor discovery and topology discovery is centralized. The centralized control plane 576 has a south bound interface 582 with a data plane 580 (sometime referred to the infrastructure layer, network forwarding plane, or forwarding plane (which should not be confused with a ND forwarding plane)) that includes the NEs 570A-H (sometimes referred to as switches, forwarding elements, data plane elements, or nodes). The centralized control plane 576 includes a network controller 578, which includes a centralized reachability and forwarding information module 579 that determines the reachability within the network and distributes the forwarding information to the NEs 570A-H of the data plane 580 over the south bound interface 582 (which may use the OpenFlow protocol). Thus, the network intelligence is centralized in the centralized control plane 576 executing on electronic devices that are typically separate from the NDs.

For example, where the special-purpose network device 502 is used in the data plane 580, each of the control communication and configuration module(s) 532A-R of the ND control plane 524 typically include a control agent that provides the VNE side of the south bound interface 582. In this case, the ND control plane 524 (the compute resource(s) 512 executing the control communication and configuration module(s) 532A-R) performs its responsibility for participating in controlling how data (e.g., packets) is to be routed (e.g., the next hop for the data and the outgoing physical NI for that data) through the control agent communicating with the centralized control plane 576 to receive the forwarding information (and in some cases, the reachability information) from the centralized reachability and forwarding information module 579 (it should be understood that in some embodiments of the invention, the control communication and configuration module(s) 532A-R, in addition to communicating with the centralized control plane 576, may also play some role in determining reachability and/or calculating forwarding information—albeit less so than in the case of a distributed approach; such embodiments are generally considered to fall under the centralized approach 574, but may also be considered a hybrid approach).

While the above example uses the special-purpose network device 502, the same centralized approach 574 can be implemented with the general purpose network device 504 (e.g., each of the VNE 560A-R performs its responsibility for controlling how data (e.g., packets) is to be routed (e.g., the next hop for the data and the outgoing physical NI for that data) by communicating with the centralized control plane 576 to receive the forwarding information (and in some cases, the reachability information) from the centralized reachability and forwarding information module 579; it should be understood that in some embodiments of the invention, the VNEs 560A-R, in addition to communicating with the centralized control plane 576, may also play some role in determining reachability and/or calculating forwarding information—albeit less so than in the case of a distributed approach) and the hybrid network device 506. In fact, the use of SDN techniques can enhance the NFV techniques typically used in the general purpose network device 504 or hybrid network device 506 implementations as NFV is able to support SDN by providing an infrastructure upon which the SDN software can be run, and NFV and SDN both aim to make use of commodity server hardware and physical switches.

FIG. 5D also shows that the centralized control plane 576 has a north bound interface 584 to an application layer 586, in which resides application(s) 588. The centralized control plane 576 has the ability to form virtual networks 592 (sometimes referred to as a logical forwarding plane, network services, or overlay networks (with the NEs 570A-H of the data plane 580 being the underlay network)) for the application(s) 588. Thus, the centralized control plane 576 maintains a global view of all NDs and configured NEs/VNEs, and it maps the virtual networks to the underlying NDs efficiently (including maintaining these mappings as the physical network changes either through hardware (ND, link, or ND component) failure, addition, or removal).

While FIG. 5D shows the distributed approach 572 separate from the centralized approach 574, the effort of network control may be distributed differently or the two combined in certain embodiments of the invention. For example: 1) embodiments may generally use the centralized approach (SDN) 574, but have certain functions delegated to the NEs (e.g., the distributed approach may be used to implement one or more of fault monitoring, performance monitoring, protection switching, and primitives for neighbor and/or topology discovery); or 2) embodiments of the invention may perform neighbor discovery and topology discovery via both the centralized control plane and the distributed protocols, and the results compared to raise exceptions where they do not agree. Such embodiments are generally considered to fall under the centralized approach 574, but may also be considered a hybrid approach.

While FIG. 5D illustrates the simple case where each of the NDs 500A-H implements a single NE 570A-H, it should be understood that the network control approaches described with reference to FIG. 5D also work for networks where one or more of the NDs 500A-H implement multiple VNEs (e.g., VNEs 530A-R, VNEs 560A-R, those in the hybrid network device 506). Alternatively or in addition, the network controller 578 may also emulate the implementation of multiple VNEs in a single ND. Specifically, instead of (or in addition to) implementing multiple VNEs in a single ND, the network controller 578 may present the implementation of a VNE/NE in a single ND as multiple VNEs in the virtual networks 592 (all in the same one of the virtual network(s) 592, each in different ones of the virtual network(s) 592, or some combination). For example, the network controller 578 may cause an ND to implement a single VNE (a NE) in the underlay network, and then logically divide up the resources of that NE within the centralized control plane 576 to present different VNEs in the virtual network(s) 592 (where these different VNEs in the overlay networks are sharing the resources of the single VNE/NE implementation on the ND in the underlay network).

On the other hand, FIGS. 5E and 5F respectively illustrate exemplary abstractions of NEs and VNEs that the network controller 578 may present as part of different ones of the virtual networks 592. FIG. 5E illustrates the simple case of where each of the NDs 500A-H implements a single NE 570A-H (see FIG. 5D), but the centralized control plane 576 has abstracted multiple of the NEs in different NDs (the NEs 570A-C and G-H) into (to represent) a single NE 5701 in one of the virtual network(s) 592 of FIG. 5D, according to some embodiments of the invention. FIG. 5E shows that in this virtual network, the NE 5701 is coupled to NE 570D and 570F, which are both still coupled to NE 570E.

FIG. 5F illustrates a case where multiple VNEs (VNE 570A.1 and VNE 570H.1) are implemented on different NDs (ND 500A and ND 500H) and are coupled to each other, and where the centralized control plane 576 has abstracted these multiple VNEs such that they appear as a single VNE 570T within one of the virtual networks 592 of FIG. 5D, according to some embodiments of the invention. Thus, the abstraction of a NE or VNE can span multiple NDs.

While some embodiments of the invention implement the centralized control plane 576 as a single entity (e.g., a single instance of software running on a single electronic device), alternative embodiments may spread the functionality across multiple entities for redundancy and/or scalability purposes (e.g., multiple instances of software running on different electronic devices).

Similar to the network device implementations, the electronic device(s) running the centralized control plane 576, and thus the network controller 578 including the centralized reachability and forwarding information module 579, may be implemented a variety of ways (e.g., a special purpose device, a general-purpose (e.g., COTS) device, or hybrid device). These electronic device(s) would similarly include compute resource(s), a set or one or more physical NICs, and a non-transitory machine-readable storage medium having stored thereon the centralized control plane software. The centralized control plane 576 transmits relevant messages to the data plane 580 based on calculations and middleware layer mapping for each flow. A flow may be defined as a set of packets whose headers match a given pattern of bits; in this sense, traditional IP forwarding is also flow—based forwarding where the flows are defined by the destination IP address for example; however, in other implementations, the given pattern of bits used for a flow definition may include more fields (e.g., 10 or more) in the packet headers. Different NDs/NEs/VNEs of the data plane 580 may receive different messages, and thus different forwarding information. The data plane 580 processes these messages and programs the appropriate flow information and corresponding actions in the forwarding tables (sometime referred to as flow tables) of the appropriate NE/VNEs, and then the NEs/VNEs map incoming packets to flows represented in the forwarding tables and forward packets based on the matches in the forwarding tables. Standards such as OpenFlow define the protocols used for the messages, as well as a model for processing the packets. The model for processing packets includes header parsing, packet classification, and making forwarding decisions. Header parsing describes how to interpret a packet based upon a well-known set of protocols. Some protocol fields are used to build a match structure (or key) that will be used in packet classification (e.g., a first key field could be a source media access control (MAC) address, and a second key field could be a destination MAC address).

Packet classification involves executing a lookup in memory to classify the packet by determining which entry (also referred to as a forwarding table entry or flow entry) in the forwarding tables best matches the packet based upon the match structure, or key, of the forwarding table entries. It is possible that many flows represented in the forwarding table entries can correspond/match to a packet; in this case the system is typically configured to determine one forwarding table entry from the many according to a defined scheme (e.g., selecting a first forwarding table entry that is matched). Forwarding table entries include both a specific set of match criteria (a set of values or wildcards, or an indication of what portions of a packet should be compared to a particular value/values/wildcards, as defined by the matching capabilities—for specific fields in the packet header, or for some other packet content), and a set of one or more actions for the data plane to take on receiving a matching packet. For example, an action may be to push a header onto the packet, for the packet using a particular port, flood the packet, or simply drop the packet. Thus, a forwarding table entry for IPv4/IPv6 packets with a particular transmission control protocol (TCP) destination port could contain an action specifying that these packets should be dropped.

Making forwarding decisions and performing actions occurs, based upon the forwarding table entry identified during packet classification, by executing the set of actions identified in the matched forwarding table entry on the packet.

However, when an unknown packet (for example, a “missed packet” or a “match-miss” as used in OpenFlow parlance) arrives at the data plane 580, the packet (or a subset of the packet header and content) is typically forwarded to the centralized control plane 576. The centralized control plane 576 will then program forwarding table entries into the data plane 580 to accommodate packets belonging to the flow of the unknown packet. Once a specific forwarding table entry has been programmed into the data plane 580 by the centralized control plane 576, the next packet with matching credentials will match that forwarding table entry and take the set of actions associated with that matched entry.

A network interface (NI) may be physical or virtual; and in the context of IP, an interface address is an IP address assigned to a NI, be it a physical NI or virtual NI. A virtual NI may be associated with a physical NI, with another virtual interface, or stand on its own (e.g., a loopback interface, a point-to-point protocol interface). A NI (physical or virtual) may be numbered (a NI with an IP address) or unnumbered (a NI without an IP address). A loopback interface (and its loopback address) is a specific type of virtual NI (and IP address) of a NE/VNE (physical or virtual) often used for management purposes; where such an IP address is referred to as the nodal loopback address. The IP address(es) assigned to the NI(s) of a ND are referred to as IP addresses of that ND; at a more granular level, the IP address(es) assigned to NI(s) assigned to a NE/VNE implemented on a ND can be referred to as IP addresses of that NE/VNE.

Next hop selection by the routing system for a given destination may resolve to one path (that is, a routing protocol may generate one next hop on a shortest path); but if the routing system determines there are multiple viable next hops (that is, the routing protocol generated forwarding solution offers more than one next hop on a shortest path—multiple equal cost next hops), some additional criteria is used—for instance, in a connectionless network, Equal Cost Multi Path (ECMP) (also known as Equal Cost Multi Pathing, multipath forwarding and IP multipath) (RFC 2991 and 2992) may be used (e.g., typical implementations use as the criteria particular header fields to ensure that the packets of a particular packet flow are always forwarded on the same next hop to preserve packet flow ordering). For purposes of multipath forwarding, a packet flow is defined as a set of packets that share an ordering constraint. As an example, the set of packets in a particular TCP transfer sequence need to arrive in order, else the TCP logic will interpret the out of order delivery as congestion and slow the TCP transfer rate down.

A Layer 3 (L3) Link Aggregation (LAG) link is a link directly connecting two NDs with multiple IP-addressed link paths (each link path is assigned a different IP address), and a load distribution decision across these different link paths is performed at the ND forwarding plane; in which case, a load distribution decision is made between the link paths.

Some NDs include functionality for authentication, authorization, and accounting (AAA) protocols (e.g., RADIUS (Remote Authentication Dial-In User Service), Diameter, and/or TACACS+ (Terminal Access Controller Access Control System Plus). AAA can be provided through a client/server model, where the AAA client is implemented on a ND and the AAA server can be implemented either locally on the ND or on a remote electronic device coupled with the ND. Authentication is the process of identifying and verifying a subscriber. For instance, a subscriber might be identified by a combination of a username and a password or through a unique key. Authorization determines what a subscriber can do after being authenticated, such as gaining access to certain electronic device information resources (e.g., through the use of access control policies). Accounting is recording user activity. By way of a summary example, end user devices may be coupled (e.g., through an access network) through an edge ND (supporting AAA processing) coupled to core NDs coupled to electronic devices implementing servers of service/content providers. AAA processing is performed to identify for a subscriber the subscriber record stored in the AAA server for that subscriber. A subscriber record includes a set of attributes (e.g., subscriber name, password, authentication information, access control information, rate-limiting information, policing information, unique residential APN) used during processing of that subscriber's traffic. In embodiments of the invention, authorization, authentication and authorization are determined based on the unique APN associated with the residential service of the subscriber.

Certain NDs (e.g., certain edge NDs) internally represent end user devices (or sometimes customer premise equipment (CPE) such as a residential gateway (e.g., a router, modem)) using subscriber circuits. A subscriber circuit uniquely identifies within the ND a subscriber session and typically exists for the lifetime of the session. Thus, a ND typically allocates a subscriber circuit when the subscriber connects to that ND, and correspondingly de-allocates that subscriber circuit when that subscriber disconnects. Each subscriber session represents a distinguishable flow of packets communicated between the ND and an end user device (or sometimes CPE such as a residential gateway or modem) using a protocol, such as the point-to-point protocol over another protocol (PPPoX) (e.g., where X is Ethernet or Asynchronous Transfer Mode (ATM)), Ethernet, 802.1Q Virtual LAN (VLAN), Internet Protocol, or ATM). A subscriber session can be initiated using a variety of mechanisms (e.g., manual provisioning a dynamic host configuration protocol (DHCP), DHCP/client-less internet protocol service (CLIPS) or Media Access Control (MAC) address tracking) For example, the point-to-point protocol (PPP) is commonly used for digital subscriber line (DSL) services and requires installation of a PPP client that enables the subscriber to enter a username and a password, which in turn may be used to select a subscriber record. When DHCP is used (e.g., for cable modem services), a username typically is not provided; but in such situations other information (e.g., information that includes the MAC address of the hardware in the end user device (or CPE)) is provided. The use of DHCP and CLIPS on the ND captures the MAC addresses and uses these addresses to distinguish subscribers and access their subscriber records.

A virtual circuit (VC), synonymous with virtual connection and virtual channel, is a connection oriented communication service that is delivered by means of packet mode communication. Virtual circuit communication resembles circuit switching, since both are connection oriented, meaning that in both cases data is delivered in correct order, and signaling overhead is required during a connection establishment phase. Virtual circuits may exist at different layers. For example, at layer 4, a connection oriented transport layer datalink protocol such as Transmission Control Protocol (TCP) (RFC 793 and 1180) may rely on a connectionless packet switching network layer protocol such as IP, where different packets may be routed over different paths, and thus be delivered out of order. Where a reliable virtual circuit is established with TCP on top of the underlying unreliable and connectionless IP protocol, the virtual circuit is identified by the source and destination network socket address pair, i.e. the sender and receiver IP address and port number. However, a virtual circuit (RFC 1180, 955, and 1644) is possible since TCP includes segment numbering and reordering on the receiver side to prevent out-of-order delivery. Virtual circuits are also possible at Layer 3 (network layer) and Layer 2 (datalink layer); such virtual circuit protocols are based on connection oriented packet switching, meaning that data is always delivered along the same network path, i.e. through the same NEs/VNEs. In such protocols, the packets are not routed individually and complete addressing information is not provided in the header of each data packet; only a small virtual channel identifier (VCI) is required in each packet; and routing information is transferred to the NEs/VNEs during the connection establishment phase; switching only involves looking up the virtual channel identifier in a table rather than analyzing a complete address. Examples of network layer and datalink layer virtual circuit protocols, where data always is delivered over the same path: X.25, where the VC is identified by a virtual channel identifier (VCI); Frame relay, where the VC is identified by a VCI; Asynchronous Transfer Mode (ATM), where the circuit is identified by a virtual path identifier (VPI) and virtual channel identifier (VCI) pair; General Packet Radio Service (GPRS); and Multiprotocol label switching (MPLS) (RFC 3031), which can be used for IP over virtual circuits (Each circuit is identified by a label).

Certain NDs (e.g., certain edge NDs) use a hierarchy of circuits. The leaf nodes of the hierarchy of circuits are subscriber circuits. The subscriber circuits have parent circuits in the hierarchy that typically represent aggregations of multiple subscriber circuits, and thus the network segments and elements used to provide access network connectivity of those end user devices to the ND. These parent circuits may represent physical or logical aggregations of subscriber circuits (e.g., a virtual local area network (VLAN), a permanent virtual circuit (PVC) (e.g., for Asynchronous Transfer Mode (ATM)), a circuit-group, a channel, a pseudo-wire, a physical NI of the ND, and a link aggregation group). A circuit-group is a virtual construct that allows various sets of circuits to be grouped together for configuration purposes, for example aggregate rate control. A pseudo-wire is an emulation of a layer 2 point-to-point connection-oriented service. A link aggregation group is a virtual construct that merges multiple physical NIs for purposes of bandwidth aggregation and redundancy. Thus, the parent circuits physically or logically encapsulate the subscriber circuits.

Each VNE (e.g., a virtual router, a virtual bridge (which may act as a virtual switch instance in a Virtual Private LAN Service (VPLS) (RFC 4761 and 4762) is typically independently administrable. For example, in the case of multiple virtual routers, each of the virtual routers may share system resources but is separate from the other virtual routers regarding its management domain, AAA (authentication, authorization, and accounting) name space, IP address, and routing database(s). Multiple VNEs may be employed in an edge ND to provide direct network access and/or different classes of services for subscribers of service and/or content providers.

Within certain NDs, “interfaces” that are independent of physical NIs may be configured as part of the VNEs to provide higher-layer protocol and service information (e.g., Layer 3 addressing). The subscriber records in the AAA server identify, in addition to the other subscriber configuration requirements, to which context (e.g., which of the VNEs/NEs) the corresponding subscribers should be bound within the ND. As used herein, a binding forms an association between a physical entity (e.g., physical NI, channel) or a logical entity (e.g., circuit such as a subscriber circuit or logical circuit (a set of one or more subscriber circuits)) and a context's interface over which network protocols (e.g., routing protocols, bridging protocols) are configured for that context. Subscriber data flows on the physical entity when some higher-layer protocol interface is configured and associated with that physical entity.

Some NDs provide support for implementing VPNs (Virtual Private Networks) (e.g., Layer 2 VPNs and/or Layer 3 VPNs). For example, the ND where a provider's network and a customer's network are coupled are respectively referred to as PEs (Provider Edge) and CEs (Customer Edge). In a Layer 2 VPN, forwarding typically is performed on the CE(s) on either end of the VPN and traffic is sent across the network (e.g., through one or more PEs coupled by other NDs). Layer 2 circuits are configured between the CEs and PEs (e.g., an Ethernet port, an ATM permanent virtual circuit (PVC), a Frame Relay PVC). In a Layer 3 VPN, routing typically is performed by the PEs. By way of example, an edge ND that supports multiple VNEs may be deployed as a PE; and a VNE may be configured with a VPN protocol, and thus that VNE is referred as a VPN VNE.

Some NDs provide support for VPLS (Virtual Private LAN Service) (RFC 4761 and 4762). For example, in a VPLS network, end user devices access content/services provided through the VPLS network by coupling to CEs, which are coupled through PEs coupled by other NDs. VPLS networks can be used for implementing triple play network applications (e.g., data applications (e.g., high-speed Internet access), video applications (e.g., television service such as IPTV (Internet Protocol Television), VoD (Video-on-Demand) service), and voice applications (e.g., VoIP (Voice over Internet Protocol) service)), VPN services, etc. VPLS is a type of layer 2 VPN that can be used for multi-point connectivity. VPLS networks also allow end use devices that are coupled with CEs at separate geographical locations to communicate with each other across a Wide Area Network (WAN) as if they were directly attached to each other in a Local Area Network (LAN) (referred to as an emulated LAN).

In VPLS networks, each CE typically attaches, possibly through an access network (wired and/or wireless), to a bridge module of a PE via an attachment circuit (e.g., a virtual link or connection between the CE and the PE). The bridge module of the PE attaches to an emulated LAN through an emulated LAN interface. Each bridge module acts as a “Virtual Switch Instance” (VSI) by maintaining a forwarding table that maps MAC addresses to pseudowires and attachment circuits. PEs forward frames (received from CEs) to destinations (e.g., other CEs, other PEs) based on the MAC destination address field included in those frames.

For example, while the flow diagrams in the figures show a particular order of operations performed by certain embodiments of the invention, it should be understood that such order is exemplary (e.g., alternative embodiments may perform the operations in a different order, combine certain operations, overlap certain operations, etc.).

While the invention has been described in terms of several embodiments, those skilled in the art will recognize that the invention is not limited to the embodiments described, can be practiced with modification and alteration within the spirit and scope of the appended claims. The description is thus to be regarded as illustrative instead of limiting.

What is claimed is:

1. A method of delivering a residential service to an electronic device of a user over a network, the method comprising:
receiving a request from the electronic device of the user to access a residential service associated with the user;
retrieving a unique Access Point Name (APN) identifier associated with the residential service of the user;
determining that the electronic device is authorized to access the requested residential service based on the unique APN identifier associated with the residential service of the user; and
responsive to the determination, transmitting an access authorization for the electronic device of the user to access the requested residential service.

2. The method of claim 1 further comprising determining a type of service to provide to the electronic device of the user based on the unique APN identifier.

3. The method of claim 1, wherein the unique APN identifier is associated with a plurality of bearers, and wherein each bearer is used to provide a service to the electronic device from at least one of: an Internet access service, a Voice over IP service, a video streaming service, and a home security monitoring service.

4. The method of claim 1, wherein the request includes a unique identifier associated with a residence of the user, and wherein retrieving the unique APN identifier is based on the unique identifier associated with the residence of the user.

5. The method of claim 1, wherein the method further comprises:
responsive to determining that the electronic device is not authorized to access the residential service,
transmitting a request for authentication parameters to the user of the electronic device;
receiving the authentication parameters; and
determining, using the authentication parameters and the unique APN identifier associated with the residential service of the user, that the electronic device is authorized to access the residential service.

6. The method of claim 1, wherein the request to access the residential service is a Layer 2 request received through a network device associated with the residential service of the user.

7. The method of claim 1, wherein the request to access the residential service is received from a public network access point which is not associated with the residential service of the user.

8. The method of claim 1, wherein the request includes a unique identifier associated with the electronic device of the user, and wherein retrieving the unique APN identifier is based on the unique identifier associated with the electronic device.

9. The method of claim 8, wherein the electronic device is a first electronic device and the unique identifier of the first electronic device is a first unique identifier and the method further comprises receiving a second request from a second electronic device to access the residential service, wherein the second request includes a second unique identifier associated with the second electronic device.

10. The method of claim 9 further comprising:
retrieving, based on the second unique identifier of the second electronic device, a second unique Access Point Name (APN) identifier associated with the residential service of the user;
determining that the second electronic device is authorized to access the requested residential service based on the second unique APN identifier;
determining a second type of service associated with the second unique APN identifier different from a first type of service associated with the first unique APN identifier; and
responsive to the determination, transmitting an access authorization for the second electronic device of the user to access the requested residential service according to the determined second type of service.

11. The method of claim 1 further comprising allocating an IP address to the electronic device of the user based on the unique APN identifier associated with the user.

12. A non-transitory machine-readable storage medium that provides instructions, which when executed by a processor, cause said processor to perform operations comprising:
receiving a request from an electronic device of the user to access a residential service associated with the user;
retrieving a unique Access Point Name (APN) identifier associated with the residential service of the user;
determining that the electronic device is authorized to access the requested residential service based on the unique APN identifier associated with the residential service of the user; and
responsive to the determination, transmitting an access authorization for the electronic device of the user to access the requested residential service.

13. The non-transitory machine-readable storage medium of claim 12, wherein the operations further comprise:
determining a type of service to provide to the electronic device of the user based on the unique APN identifier.

14. The non-transitory machine readable storage medium of claim 12, wherein the unique APN identifier is associated with a plurality of bearers, and wherein each bearer is used to provide a service to the electronic device from at least one of: an Internet access service, a Voice over IP service, a video streaming service, and a home security monitoring service.

15. The non-transitory machine-readable storage medium of claim 12, wherein the request includes a unique identifier associated with a residence of the user, and wherein retrieving the unique APN identifier is based on the unique identifier associated with the residence of the user.

16. The non-transitory machine-readable storage medium of claim 12, wherein determining that the electronic device is authorized to access the residential service further includes:
responsive to determining that the electronic device is not authorized to access the residential service,
transmitting a request for authentication parameters to the user of the electronic device;
receiving the authentication parameters; and
determining, using the authentication parameters and the unique APN identifier associated with the residential service of the user, that the electronic device is authorized to access the residential service.

17. The non-transitory machine-readable storage medium of claim 12, wherein the request to access the residential service is a Layer 2 request received through a network device associated with the residential service of the user.

18. The non-transitory machine-readable storage medium of claim 12, wherein the request to access the residential service is received from a public network access point which is not associated with the residential service of the user.

19. The non-transitory machine-readable storage medium of claim 12, wherein the request includes a unique identifier associated with the electronic device of the user, and wherein retrieving the unique APN identifier is based on the unique identifier associated with the electronic device.

20. The non-transitory machine-readable storage medium of claim 19, wherein the electronic device is a first electronic device and the unique identifier of the first electronic device is a first unique identifier and the method further comprises receiving a second request from a second electronic device to access the residential service, wherein the second request includes a second unique identifier associated with the second electronic device.

21. The non-transitory machine-readable storage medium of claim 12, wherein the operations further comprise:
retrieving, based on the second unique identifier of the second electronic device, a second unique Access Point Name (APN) identifier associated with the residential service of the user;
determining that the second electronic device is authorized to access the requested residential service based on the second unique APN identifier;
determining a second type of service associated with the second unique APN identifier different from a first type of service associated with the first unique APN identifier; and
responsive to the determination, transmitting an access authorization for the second electronic device of the user to access the requested residential service according to the determined second type of service.

22. The non-transitory machine-readable storage medium of claim 12, wherein the operations further comprise allocating an IP address to the electronic device of the user based on the unique APN identifier associated with the user.
